(19) United States
(12) Patent Application Publication
(10) Pub. No.: US 2025/0070465 A1
(43) Pub. Date: Feb. 27, 2025

(54) ELECTRONIC DEVICE

(71) Applicant: HUAWEI TECHNOLOGIES CO., LTD., Shenzhen, Guangdong (CN)

(72) Inventors: Libin SUN, Shanghai (CN); Lishun KE, Shanghai (CN); Hanyang WANG, Reading (GB)

(21) Appl. No.: 18/941,628

(22) Filed: Nov. 8, 2024

Related U.S. Application Data
(63) Continuation of application No. PCT/CN2023/093650, filed on May 11, 2023.

(30) Foreign Application Priority Data
May 17, 2022 (CN) 202210534097.9

(51) Int. Cl. H01Q 5/25; H01Q 9/04; H01Q 21/22

(52) U.S. Cl. CPC H01Q 5/25; H01Q 9/0428; H01Q 21/22

(57) ABSTRACT

An electronic device includes a conductive frame and an antenna. A part of the frame is used as a radiator of the antenna. The antenna is used to generate a first resonance and a second resonance. A ratio of a frequency of the first resonance to a frequency of the second resonance is greater than 1 and less than or equal to 1.5. An operating frequency band of the antenna includes a first frequency band, and a frequency in the first frequency band is between the frequency of the first resonance and the frequency of the second resonance.

### CROSS-REFERENCE TO RELATED APPLICATIONS

This application is a continuation of International Application No. PCT/CN2023/093650, filed on May 11, 2023, which claims priority to Chinese Patent Application No. 202210534097.9, filed on May 17, 2022. The disclosures of the aforementioned applications are hereby incorporated by reference in their entireties.

### TECHNICAL FIELD

This application relates to the wireless communication field, and in particular, to an electronic device.

### BACKGROUND

In a satellite navigation or communication system, compared with a linearly polarized antenna, a circularly polarized antenna has some unique advantages. For example, a polarization rotation (commonly referred to as “Faraday rotation”) occurs when linearly polarized waves pass through the ionosphere, and circularly polarized waves have rotational symmetry and can resist the Faraday rotation. Therefore, the circularly polarized antenna is generally used as a transmit or receive antenna for satellite navigation or communication. In addition, in the satellite navigation or communication system, if the conventional linearly polarized antenna is used to receive circularly polarized waves from a satellite, half of energy is lost due to polarization mismatch.

However, due to factors such as industrial design (ID) and an overall structure of an electronic device, currently, antennas designed for existing terminal electronic devices are linearly polarized antennas, and circular polarization of the antennas has not been studied. However, on an existing dedicated satellite terminal, an external antenna is generally used to implement circular polarization. Most of antennas take the form of large-volume quadrifilar helix antennas, and built-in integration of the antennas cannot be implemented. Therefore, the design of a built-in or conformal circularly polarized antenna is significant for implementing functions such as satellite communication or navigation in a terminal electronic device.

### SUMMARY

Embodiments of this application provide an electronic device, including an antenna structure. The antenna structure is disposed in the electronic device in a built-in manner. A metal frame is used as a radiator, to implement circular polarization in a small-clearance environment.

According to a first aspect, an electronic device is provided, including: a conductive frame, where the frame has a first position and a second position, and a frame between the first position and the second position is a first frame; and an antenna, including the first frame, where the antenna is configured to generate a first resonance and a second resonance. A ratio of a frequency of the first resonance to a frequency of the second resonance is greater than 1 and less than or equal to 1.5. An operating frequency band of the antenna includes a first frequency band, and a frequency in the first frequency band is between the frequency of the first resonance and the frequency of the second resonance. An axial ratio of circular polarization of the antenna in the first frequency band is less than or equal to 10 dB.

According to the technical solution in an embodiment of the application, a frequency by which the first resonance is spaced from the second resonance is adjusted, so that the antenna may have two orthogonal polarization modes in the first frequency band with frequencies between the frequency of the first resonance and the frequency of the second resonance. In the first frequency band, the antenna may implement circular polarization through the two orthogonal polarization modes (the axial ratio of circular polarization is less than or equal to 10 dB).

In addition, the technical solution provided in this application may be applied to a combination of a CM mode of a linear antenna and a DM mode of the linear antenna, a combination of a CM mode of a slot antenna and a DM mode of the slot antenna, a combination of the CM mode of the linear antenna and the CM mode of the slot antenna, or a combination of the DM mode of the linear antenna and the DM mode of the slot antenna. This is not limited in this application, and may be adjusted based on a layout in the electronic device.

With reference to the first aspect, in an embodiment of the first aspect, a polarization manner for the first resonance is orthogonal to a polarization manner for the second resonance.

With reference to the first aspect, in an embodiment of the first aspect, in the first frequency band, a difference between a first gain generated by the antenna and a second gain generated by the antenna is less than 10 dB. The first gain is a gain of a pattern generated by the antenna in a first polarization direction. The second gain is a gain of a pattern generated by the antenna in a second polarization direction. The first polarization direction is orthogonal to the second polarization direction.

According to the technical solution in an embodiment of the application, the difference between the first gain generated by the antenna and the second gain generated by the antenna structure is less than 10 dB, so that the antenna has good circular polarization.

With reference to the first aspect, in an embodiment of the first aspect, in the first frequency band, a difference between a first phase generated by the antenna and a second phase generated by the antenna is greater than 25° and less than 155°. The first phase is a phase of the antenna in the first polarization direction. The second phase is a phase of the antenna in the second polarization direction. The first polarization direction is orthogonal to the second polarization direction.

According to the technical solution in an embodiment of the application, the difference between the first phase generated by the antenna and the second phase generated by the antenna is greater than 25° and less than 155° (90°+65°), so that the antenna has good circular polarization.

With reference to the first aspect, in an embodiment of the first aspect, a ratio of the frequency of the first resonance to the frequency of the second resonance is greater than or equal to 1.2 and less than or equal to 1.35.

According to the technical solution in an embodiment of the application, the ratio of the frequency of the first resonance to the frequency of the second resonance is greater than or equal to 1.2 and less than or equal to 1.35, so that the antenna has good circular polarization.

With reference to the first aspect, in an embodiment of the first aspect, the antenna further includes a ground plate. The first frame includes a ground point. For the ground plate, the first frame is grounded at the ground point through the ground plate.

According to the technical solution in an embodiment of the application, the antenna may be a T-shaped antenna. The first resonance is generated in the DM mode, and the second resonance is generated in the CM mode. The frequency by which the first resonance is spaced from the second resonance is adjusted, so that the antenna may have both the CM mode and the DM mode in the first frequency band with frequencies between the frequency of the first resonance and the frequency of the second resonance. In the first frequency band, circular polarization may be implemented in the CM mode and the DM mode with orthogonal polarizations.

With reference to the first aspect, in an embodiment of the first aspect, in the first frequency band, a current on the first frame is symmetrically distributed along the ground point at a first moment, and the current on the first frame is asymmetrically distributed along the ground point at a second moment.

According to the technical solution in an embodiment of the application, because the antenna has both the CM mode and the DM mode in the first frequency band, the current on the first frame presents different distribution states at different moments in a cycle.

With reference to the first aspect, in an embodiment of the first aspect, the ground point is disposed in a central region of the first frame.

According to the technical solution in an embodiment of the application, the ground point may be disposed in the central region of the first frame, so that the antenna forms a symmetrical T-shaped antenna. The central region may be considered as a region within a distance to the geometric center or a center of an electrical length of the first frame. For example, the central region may be a region within 5 mm to the geometric center of the first frame, may be a region within three-eighths to five-eighths of a physical length of the first frame to the first frame, or may be a region within three-eighths to five-eighths of the electrical length of the first frame to the first frame.

With reference to the first aspect, in an embodiment of the first aspect, the first frame is divided into a first radiator part and a second radiator part by the ground point, and an electrical length of the first radiator part is different from an electrical length of the second radiator part.

According to the technical solution in an embodiment of the application, the ground point is disposed off the central region of the first frame, so that the electrical length of the first radiator part is different from the electrical length of the second radiator part, to form an asymmetrical T-shaped structure. Because a length of the first radiator part is different from a length of the second radiator part, when an electrical signal is fed into the first frame, the first resonance may be generated when the entire first frame operates in the DM mode, the second resonance may be generated when the first radiator part operates in the CM mode, and third resonance may be generated when the second radiator part operates in the CM mode.

With reference to the first aspect, in an embodiment of the first aspect, the antenna is further configured to generate the third resonance. A ratio of a frequency of the third resonance to the frequency of the first resonance is greater than 1 and less than or equal to 1.5. An operating frequency band of the antenna includes a second frequency band, and a frequency in the second frequency band is between the frequency of the first resonance and the frequency of the third resonance. An axial ratio of circular polarization of the antenna in the second frequency band is less than or equal to 10 dB.

According to the technical solution in an embodiment of the application, when the ratio of the frequency of the third resonance to the frequency of the first resonance is greater than 1 and less than or equal to 1.5, the second frequency band exists between the frequency of the third resonance and the frequency of the first resonance. In the frequency band, both the CM mode and the DM mode exist.

With reference to the first aspect, in an embodiment of the first aspect, the electronic device further includes a capacitor. One end of the capacitor is electrically connected to the first frame at the ground point, and the other end of the capacitor is grounded.

According to the technical solution of an embodiment of the application, the capacitor is disposed between the ground point and the ground plate (one end of the capacitor is electrically connected to the radiator at the ground point, and the other end is grounded), so that the frequency of the second resonance may be shifted to a high frequency.

With reference to the first aspect, in an embodiment of the first aspect, the antenna further includes a ground plate. For the ground plate, the first frame is grounded at the first position and the second position through the ground plate. The first frame has a slot.

According to the technical solution in an embodiment of the application, the antenna may be a slot antenna. The first resonance is generated in the DM mode, and the second resonance is generated in the CM mode. The frequency by which the first resonance is spaced from the second resonance is adjusted, so that the antenna may have both the CM mode and the DM mode in the first frequency band with frequencies between the frequency of the first resonance and the frequency of the second resonance. In the first frequency band, circular polarization may be implemented in the CM mode and the DM mode with orthogonal polarizations.

With reference to the first aspect, in an embodiment of the first aspect, in a third frequency band, an electric field between the first frame and the ground plate is symmetrically distributed along a virtual axis of the first frame at a first moment, and the electric field between the first frame and the ground plate is asymmetrically distributed along the virtual axis at a second moment.

According to the technical solution in an embodiment of the application, because the antenna has both the CM mode and the DM mode in the first frequency band, the current on the first frame presents different distribution states at different moments in a cycle.

With reference to the first aspect, in an embodiment of the first aspect, the slot is disposed in a central region of the first frame.

According to the technical solution in an embodiment of the application, the slot may be disposed in the central region of the first frame, so that the antenna forms a symmetrical slot antenna.

With reference to the first aspect, in an embodiment of the first aspect, the first frame is divided into a first radiator part and a second radiator part by the slot, and an electrical length of the first radiator part is different from an electrical length of the second radiator part.

According to the technical solution in an embodiment of the application, the slot is disposed off the central region of the first frame, so that the electrical length of the first radiator part is different from the electrical length of the second radiator part, to form an asymmetrical slot structure. In this way, the antenna generates extra resonance.

With reference to the first aspect, in an embodiment of the first aspect, the antenna is further configured to generate the third resonance. A ratio of a frequency of the third resonance to the frequency of the first resonance is greater than 1 and less than or equal to 1.5. An operating frequency band of the antenna includes a second frequency band, and a frequency in the second frequency band is between the frequency of the first resonance and the frequency of the third resonance. An axial ratio of circular polarization of the antenna in the second frequency band is less than or equal to 10 dB.

According to the technical solution in an embodiment of the application, when the ratio of the frequency of the third resonance to the frequency of the first resonance is greater than 1 and less than or equal to 1.5, the second frequency band exists between the frequency of the third resonance and the frequency of the first resonance. In the frequency band, both the CM mode and the DM mode exist.

With reference to the first aspect, in an embodiment of the first aspect, the electronic device further includes an inductor. Two ends of the inductor are electrically connected to the first frame on two sides of the slot separately.

According to the technical solution in an embodiment of the application, the inductor may be configured to adjust the frequency of the second resonance, so that the frequency of the first resonance and the frequency of the second resonance meet a requirement.

With reference to the first aspect, in an embodiment of the first aspect, the electronic device further includes a resonant stub. The frame includes a first edge and a second edge that intersect at an angle. At least a part of the first frame is located on the first edge. The resonant stub is disposed between the second edge and the ground plate, and one end of the resonant stub is electrically connected to the ground plate. A distance between the resonant stub and the first frame is less than half of a length of the second edge.

According to the technical solution in an embodiment of the application, in an application process of a circularly polarized antenna, because the electronic device needs to communicate with a satellite, the antenna needs to generate a directional beam to better establish a connection to the satellite. Because the ground plate in the electronic device is large and the current is pulled by the ground plate, a pattern generated by the antenna is often uncontrollable. A current distribution on the ground plate may be adjusted by connecting the resonant stub to the ground plate, to control the pattern generated by the antenna. In addition, because the resonant stub may also generate radiation, a generated pattern may be superimposed on the pattern generated by the antenna. This can improve radiation performance of the antenna, for example, correcting an axial ratio pattern of circular polarization and a gain pattern.

With reference to the first aspect, in an embodiment of the first aspect, the frame includes a first edge and a second edge that intersect at an angle. At least a part of the first frame is located on the first edge. A slot is disposed on the ground plate corresponding to the second edge. A distance between the slot and the first frame is less than half of a length of the second edge.

According to the technical solution in an embodiment of the application, in an application process of a circularly polarized antenna, because the electronic device needs to communicate with a satellite, the antenna needs to generate a directional beam to better establish a connection to the satellite. Because the ground plate in the electronic device is large and the current is pulled by the ground plate, a pattern generated by the antenna structure is often uncontrollable. A current distribution on the ground plate may be adjusted by providing the slot on the ground plate, to control the pattern generated by the antenna. In addition, because the slot cuts off a part of the current distributed over the ground plate, this may also generate radiation. A generated pattern may be superimposed on the pattern generated by the antenna. This can improve radiation performance of the antenna, for example, correcting an axial ratio pattern of circular polarization and a gain pattern.

With reference to the first aspect, in an embodiment of the first aspect, the first frame further includes a first feed point, and the first feed point is disposed between the ground point or the slot and the first position. No feed point is included between the ground point or the slot and the second position.

According to the technical solution in an embodiment of the application, the antenna uses offset central feed (offset feed/side feed), and the antenna may generate both the CM mode and the DM mode. The structure of the antenna is simple, and is easy for performing a layout on the inside of the electronic device. The first frequency band between the resonance generated in the CM mode and the resonance generated in the DM mode may be used as an operating frequency band for circular polarization of the antenna.

With reference to the first aspect, in an embodiment of the first aspect, the electronic device further includes a switch and a feed unit. The first frame further includes a first feed point and a second feed point. The first feed point is disposed between the ground point or the slot and the first position, and the second feed point is disposed between the ground point or the slot and the second position. The switch includes a common port, a first port, and a second port. The switch is configured to switch a status of electrical connection between the common port and the first port or the second port. The common port is electrically connected to the feed unit. The first port is electrically connected to the first frame at the first feed point, and the second port is electrically connected to the first frame at the second feed point.

According to the technical solution in an embodiment of the application, a position at which the electrical signal is fed into the first frame may be changed by changing the status of electrical connection between the common port and the first port or the second port. This may change the first phase in the first polarization direction and the second phase in the second polarization direction that are generated by the antenna in the first frequency band, change a rotation direction of circular polarization, and switch between left-hand circular polarization and right-hand circular polarization.

With reference to the first aspect, in an embodiment of the first aspect, the first frame includes a first feed point and a second feed point. The first feed point is disposed between the ground point or the slot and the first position, and the second feed point is disposed between the ground point or the slot and the second position. A difference between a phase of an electrical signal fed at the first feed point and a phase of an electrical signal fed at the second feed point is 90°+25°.

According to the technical solution in an embodiment of the application, electrical signals with a fixed phase difference are fed at two feed points. Switching between right-hand circular polarization and left-hand circular polarization of the antenna may be controlled based on phases of the electrical signals fed at the first feed point and the second feed point.

With reference to the first aspect, in an embodiment of the first aspect, the electronic device further includes a feed network and a feed unit. The feed network includes an input port, a first output port, and a second output port. The input port is electrically connected to the feed unit. The first output port is electrically connected to the first frame at the first feed point, and the second output port is electrically connected to the first frame at the second feed point.

According to the technical solution in an embodiment of the application, a distributed feed network may be used, so that electrical signals fed at two feed points have equal amplitudes and the fixed phase difference, to implement circular polarization. For example, phases of the electrical signals fed at the two feed points may be implemented based on a difference between lengths of transmission lines connected to the two feed points. For example, when the difference between the lengths of the transmission lines connected to the two feed points is half of a wavelength (a wavelength corresponding to a frequency of the electrical signal), the phase difference between the electrical signals fed at the two feed points is 180°. Alternatively, when the difference between the lengths of the transmission lines connected to the two feed points is a quarter of a wavelength (a wavelength corresponding to a frequency of an electrical signal), the phase difference between the electrical signals fed at the two feed points is 90°. The phase difference between the electrical signals fed at the two feed points is greater than 30° and less than 150°. For example, the difference between the lengths of the transmission lines connected to the two feed points may be greater than one-twelfth of the wavelength and less than five-twelfths of the wavelength.

According to a second aspect, an electronic device is provided, including a first radiator, a second radiator, and a ground plate. A first end and a second end of the first radiator are grounded through the ground plate. A distance between a projection of the first radiator in a first direction and a projection of the second radiator in the first direction is less than 10 mm. The first direction is a direction perpendicular to the ground plate. The first radiator is configured to generate a first resonance, and the second radiator is configured to generate a second resonance. A ratio of a frequency in a first frequency band to a frequency in a second frequency band is greater than 1 and less than or equal to 1.5. Operating frequency bands of the first radiator and the second radiator include the first frequency band, and the frequency in the first frequency band is between a frequency of the first resonance and a frequency of the second resonance. An axial ratio of circular polarization of the first radiator and the second radiator in the first frequency band is less than or equal to 10 dB.

According to the technical solution in an embodiment of the application, the technical solution provided in this application may be applied to a combination of a CM mode of a linear antenna and a DM mode of the linear antenna, a combination of a CM mode of a slot antenna and a DM mode of the slot antenna, a combination of the CM mode of the linear antenna and the CM mode of the slot antenna, or a combination of the DM mode of the linear antenna and the DM mode of the slot antenna. This is not limited in this application, and may be adjusted based on a layout in the electronic device.

With reference to the second aspect, in an embodiment of the second aspect, the first radiator and the ground plate enclose a closed slot.

With reference to the second aspect, in an embodiment of the second aspect, no ground point is disposed on the second radiator.

With reference to the second aspect, in an embodiment of the second aspect, a frame has a first position and a second position, and a frame between the first position and the second position is a first frame. The first frame is used as the first radiator and the second radiator.

With reference to the second aspect, in an embodiment of the second aspect, a polarization manner for the first resonance is orthogonal to a polarization manner for the second resonance.

With reference to the second aspect, in an embodiment of the second aspect, in the first frequency band, a difference between a first gain generated by an antenna and a second gain generated by the antenna is less than 10 dB. The first gain is a gain of a pattern generated by the antenna in a first polarization direction. The second gain is a gain of a pattern generated by the antenna in a second polarization direction. The first polarization direction is orthogonal to the second polarization direction.

With reference to the second aspect, in an embodiment of the second aspect, in the first frequency band, a difference between a first phase generated by the antenna and a second phase generated by the antenna is greater than 25° and less than 155°. The first phase is a phase of the antenna in the first polarization direction. The second phase is a phase of the antenna in the second polarization direction. The first polarization direction is orthogonal to the second polarization direction.

With reference to the second aspect, in an embodiment of the second aspect, a ratio of the frequency of the first resonance to the frequency of the second resonance is greater than or equal to 1.2 and less than or equal to 1.35.

According to a third aspect, an electronic device is provided, including: a first radiator, at which a slot is disposed; a second radiator including a ground point; and a ground plate. A first end and a second end of the first radiator are grounded through the ground plate, and the ground point of the second radiator is grounded through the ground plate. A distance between a projection of the first radiator in a first direction and a projection of the second radiator in the first direction is less than 10 mm. The first direction is a direction perpendicular to the ground plate. The first radiator is configured to generate a first resonance, and the second radiator is configured to generate a second resonance. A ratio of a frequency in a first frequency band to a frequency in a second frequency band is greater than 1 and less than or equal to 1.5. Operating frequency bands of the first radiator and the second radiator include the first frequency band, and the frequency in the first frequency band is between a frequency of the first resonance and a frequency of the second resonance. An axial ratio of circular polarization of the first radiator and the second radiator in the first frequency band is less than or equal to 10 dB.

According to the technical solution in an embodiment of the application, the technical solution provided in this application may be applied to a combination of a CM mode of a linear antenna and a DM mode of the linear antenna, a combination of a CM mode of a slot antenna and a DM mode of the slot antenna, a combination of the CM mode of the linear antenna and the CM mode of the slot antenna, or a combination of the DM mode of the linear antenna and the DM mode of the slot antenna. This is not limited in this application, and may be adjusted based on a layout in the electronic device.

With reference to the third aspect, in an embodiment of the third aspect, the slot is disposed in a central region of the first radiator.

With reference to the third aspect, in an embodiment of the third aspect, the ground point is disposed in a central region of the second radiator.

With reference to the third aspect, in an embodiment of the third aspect, a frame has a first position and a second position, and a frame between the first position and the second position is a first frame. The first frame is used as the first radiator and the second radiator.

With reference to the third aspect, in an embodiment of the third aspect, a polarization manner for the first resonance is orthogonal to a polarization manner for the second resonance.

With reference to the third aspect, in an embodiment of the third aspect, in the first frequency band, a difference between a first gain generated by an antenna and a second gain generated by the antenna is less than 10 dB. The first gain is a gain of a pattern generated by the antenna in a first polarization direction. The second gain is a gain of a pattern generated by the antenna in a second polarization direction. The first polarization direction is orthogonal to the second polarization direction.

With reference to the third aspect, in an embodiment of the third aspect, in the first frequency band, a difference between a first phase generated by the antenna and a second phase generated by the antenna is greater than 250 and less than 155°. The first phase is a phase of the antenna in the first polarization direction. The second phase is a phase of the antenna in the second polarization direction. The first polarization direction is orthogonal to the second polarization direction.

With reference to the third aspect, in an embodiment of the third aspect, a ratio of the frequency of the first resonance to the frequency of the second resonance is greater than or equal to 1.2 and less than or equal to 1.35.

### BRIEF DESCRIPTION OF DRAWINGS

FIG. 1 is a diagram of an electronic device according to an embodiment of this application;

FIG. 2 is a diagram of a structure of a common-mode of a linear antenna and distributions of a corresponding current and electric field according to the application;

FIG. 3 is a diagram of a structure of a differential-mode of a linear antenna and distributions of a corresponding current and electric field according to the application;

FIG. 4 is a diagram of a structure of a common-mode of a slot antenna and distributions of a corresponding current, electric field, and magnetic current according to the application;

FIG. 5 is a diagram of a structure of a differential-mode of a slot antenna and distributions of a corresponding current, electric field, and magnetic current according to the application;

FIG. 6 is a diagram of a usage scenario of a circularly polarized antenna according to an embodiment of this application;

FIG. 7 is a diagram of a circularly polarized antenna according to an embodiment of this application;

FIG. 8 is a diagram of a structure of a linear antenna according to the application;

FIG. 9 is a diagram of a simulation result of the antenna structure shown in FIG. 8;

FIG. 10(a) to FIG. 10(d) are diagrams of antenna structure combinations according to the application;

FIG. 11 is a diagram of an antenna structure 100 according to an embodiment of this application;

FIG. 12 is a diagram of orthogonal polarizations according to an embodiment of this application;

FIG. 13 is an S-parameter diagram of the antenna structure 100 shown in FIG. 11;

FIG. 14 is a current distribution diagram of the antenna structure 100 shown in FIG. 11 at 2 GHz and 2.7 GHz;

FIG. 15 is an electric field distribution diagram of the antenna structure shown in FIG. 11 at different moments in a cycle;

FIG. 16 is an axial ratio pattern of circular polarization of the antenna structure shown in FIG. 11;

FIG. 17 is a gain pattern of the antenna structure shown in FIG. 11;

FIG. 18 is a curve graph of axial ratios of circular polarization of the antenna structure shown in FIG. 11;

FIG. 19 is a diagram of another antenna structure 100 according to an embodiment of this application;

FIG. 20(a) to FIG. 20(h) are diagrams of antenna structure combinations according to the application;

FIG. 21 is a diagram of another antenna structure 100 according to an embodiment of this application;

FIG. 22 is an S-parameter diagram of the antenna structure 100 shown in FIG. 21;

FIG. 23 is a gain pattern of the antenna structure shown in FIG. 21;

FIG. 24 is a curve graph of axial ratios of circular polarization of the antenna structure shown in FIG. 21;

FIG. 25(a) to FIG. 25(d) are diagrams of antenna structure combinations according to the application;

FIG. 26(a) to FIG. 26(d) are diagrams of antenna structure combinations according to the application;

FIG. 27 is a diagram of another antenna structure 100 according to an embodiment of this application;

FIG. 28 is a diagram of a simulation result of the antenna structure shown in FIG. 27;

FIG. 29(a) to FIG. 29(d) are diagrams of antenna structure combinations according to the application;

FIG. 30 is a diagram of an electronic device 10 according to an embodiment of this application;

FIG. 31 is a diagram of another electronic device 10 according to an embodiment of this application;

FIG. 32 is a diagram of another electronic device 10 according to an embodiment of this application;

FIG. 33 is an axial ratio pattern of circular polarization of the antenna structure shown in (b) in FIG. 32;

FIG. 34 is a gain pattern of the antenna structure shown in (b) in FIG. 32;

FIG. 35(a) to FIG. 35(c) are patterns corresponding to RHCP of the antenna structure shown in (b) in FIG. 32;

FIG. 36 is a diagram of an antenna structure 200 according to an embodiment of this application;

FIG. 37 is an axial ratio pattern of circular polarization of the antenna structure shown in (b) in FIG. 36;

FIG. 38 is a gain pattern of the antenna structure shown in FIG. 36;

FIG. 39(a) to FIG. 39(c) are patterns corresponding to RHCP of the antenna structure shown in FIG. 36;

FIG. 40 is a diagram of a structure of an electronic device 10 according to an embodiment of this application;

FIG. 41 is a diagram of a structure of another electronic device 10 according to an embodiment of this application;

FIG. 42 is a diagram of a structure of another electronic device 10 according to an embodiment of this application; and

FIG. 43(a) to FIG. 43(d) are diagrams of structures of another electronic device 10 according to an embodiment of this application.

### DESCRIPTION OF EMBODIMENTS

The following describes possible terms in embodiments of this application.

“Coupling” may be understood as direct coupling and/or indirect coupling, and a “coupling connection” may be understood as a direct coupling connection and/or an indirect coupling connection. The direct coupling may also be referred to as an “electrical connection”, which may be understood as that components are in physical contact and are electrically conducted, or may be understood as a form in which different components in a line structure are connected via a physical line that can transmit an electrical signal, for example, printed circuit board (PCB) copper foil or a conducting wire. The “indirect coupling” may be understood as that two conductors are electrically conducted in a spaced/a non-contact manner. In an embodiment, the indirect coupling may also be referred to as capacitive coupling. For example, signal transmission is implemented by forming equivalent capacitance through coupling of a gap between two conductive components.

“Connected”/“Connection” may mean a mechanical connection relationship or a physical connection relationship. For example, A is connected to B or a connection between A and B may mean that there is a fastening component (for example, a screw, a bolt, or a rivet) between A and B, or A and B are in contact with each other and A and B are difficult to be separated.

“Conducted” means that two or more components are conducted or connected in the foregoing “electrical connection” or “indirect coupling” manner to perform signal/energy transmission, which may be referred to as being conducted.

“Opposite”/“Disposed opposite to”: that A is disposed opposite to B means that A and B are disposed face to face (opposite to each other, or face to face).

Capacitance may be understood as lumped capacitance and/or distributed capacitance. The lumped capacitance means a capacitive component, for example, a capacitor component. The distributed capacitance (or distributed capacitance) means equivalent capacitance formed at the gap between two conductors.

Resonance/Resonance frequency: A resonance frequency is also referred to as a resonant frequency. The resonance frequency may mean a frequency at which an imaginary part of antenna input impedance is zero. The resonance frequency may fall in a frequency range, namely, a frequency range in which resonance occurs. A frequency corresponding to a point with strongest resonance is a center frequency. Return loss of a center frequency may be less than −20 dB.

Resonance frequency band: A resonance frequency range is a resonance frequency band. Return loss of any frequency in the resonance frequency band may be less than −6 dB or −5 dB.

Communication frequency band/operating frequency band: An antenna always operates within a frequency range (frequency band width), regardless of the type of antenna. For example, an operating frequency band of an antenna supporting a B40 frequency band includes frequencies within a range of 2300 MHz to 2400 MHz. In other words, the operating frequency band of the antenna includes the B40 frequency band. A frequency range that meets a specification requirement can be considered as an operating frequency band of an antenna.

The resonance frequency band and the operating frequency band may be the same or different, or frequency ranges of the resonance frequency band and the operating frequency band may partially overlap. In an embodiment, the resonance frequency band of an antenna may cover a plurality of operating frequency bands of the antenna.

Electrical length may be a ratio of a physical length (namely, a mechanical length or a geometric length) to a wavelength of a transmitted electromagnetic wave. The electrical length may meet the following formula:

$$\overline{L} = \frac{L}{λ} .$$

L is the physical length, and is A the wavelength of the electromagnetic wave.

In some embodiments of this application, a physical length of a radiator may be understood as falling within ±25% of an electrical length of the radiator.

In some embodiments of this application, a physical length of a radiator may be understood as falling within ±10% of an electrical length of the radiator.

Wavelength or an operating wavelength may be a wavelength corresponding to a center frequency of resonance frequencies or a center frequency of an operating frequency band supported by the antenna. For example, it is assumed that a center frequency of a B1 uplink frequency band (resonance frequencies of 1920 MHz to 1980 MHz) is 1955 MHz. An operating wavelength may be a wavelength calculated based on the frequency 1955 MHz. This is not limited to the center frequency. The “operating wavelength” may also mean a wavelength corresponding to a resonance frequency or a non-center frequency in the operating frequency band.

It should be understood that a wavelength of a radiated signal in air may be calculated as follows: (wavelength in air or vacuum wavelength)=speed of light/frequency, where the frequency is a frequency (MHz) of the radiated signal, and the speed of light may be 3×10⁸ m/s. A wavelength of the radiated signal in a medium may be calculated as follows: wavelength in the medium=(speed of light/\sqrt{ε})/frequency, where ε is a relative permittivity of the medium. In embodiments of this application, a wavelength generally means a wavelength in a medium, and may be the wavelength in the medium corresponding to a center frequency of resonance frequencies, or the wavelength in the medium corresponding to a center frequency of an operating frequency band supported by an antenna. For example, it is assumed that a center frequency of a B1 uplink frequency band (resonance frequencies of 1920 MHz to 1980 MHz) is 1955 MHz. A wavelength may be a wavelength in a medium calculated based on the frequency 1955 MHz. This is not limited to the center frequency. The “wavelength in the medium” may also mean a wavelength in the medium corresponding to a resonance frequency or a non-center frequency in the operating frequency band. For ease of understanding, the wavelength in the medium in embodiments of this application may be simply calculated based on a relative permittivity of the medium filled in one or more sides of the radiator.

In embodiments of this application, limitations on positions and distances such as the middle or middle position, are limitations based on a current technology level, but are not definitions in a mathematical sense. For example, the middle (position) of a conductor may be a conductor part including a midpoint of the conductor, or may be a conductor part that is of one-eighth wavelength and that includes a midpoint of the conductor. The wavelength may be a wavelength corresponding to an operating frequency band of an antenna, a wavelength corresponding to a center frequency of the operating frequency band, or a wavelength corresponding to a resonance point. For another example, the middle (position) of the conductor may be a conductor part that is at a distance, less than a predetermined threshold, from the midpoint of the conductor (for example, 1 mm, 2 mm, or 2.5 mm).

In embodiments of this application, limitations such as collinearity, coaxiality, coplanarity, symmetry (for example, axial symmetry or centrosymmetry), parallelism, perpendicularity, and sameness (for example, a same length and a same width) are limitations based on a current technology level, but are not definitions in a mathematical sense. In a conductor width direction, a deviation less than a preset threshold (for example, 1 mm, 0.5 m, or 0.1 mm) may exist between edges of two collinear radiation stubs or two collinear antenna elements. In a direction perpendicular to a coplanar plane of two coplanar radiation stubs or of two coplanar antenna elements, a deviation less than a preset threshold (for example, 1 mm, 0.5 m, or 0.1 mm) may exist between edges of the two coplanar radiation stubs or the two coplanar antenna elements. A deviation of a predetermined angle (for example, ±5° or +10°) may exist between two antenna elements that are parallel or perpendicular to each other.

An antenna total efficiency is a ratio of input power to output power of an antenna port.

An antenna radiation efficiency is a ratio of power radiated by an antenna to space (namely, power for effectively converting electromagnetic waves) to active power input to the antenna. The active power input to the antenna=input power of the antenna −loss power. The loss power mainly includes return loss power, ohmic loss power of a metal, and/or loss power of a medium. The radiation efficiency is a value that measures a radiation capability of an antenna. The radiation efficiency is affected by both metal loss and medium loss.

One of ordinary skilled in the art may understand that efficiency is generally represented using a percentage. There is a corresponding conversion relationship between the percentage and dB. A closer efficiency to 0 dB indicates better efficiency of the antenna.

Antenna return loss may be understood as a ratio of signal power reflected back to an antenna port through an antenna circuit to transmit power of the antenna port. A smaller reflected signal indicates a larger signal radiated by the antenna to space and higher radiation efficiency of the antenna. A larger reflected signal indicates a smaller signal radiated by the antenna to space and smaller radiation efficiency of the antenna.

The antenna return loss may be represented by an S11 parameter, and S11 is one type of S parameters. S11 indicates a reflection coefficient. This parameter indicates whether the transmit efficiency of the antenna is good or poor. The S11 parameter is usually a negative number. A smaller S11 parameter indicates smaller return loss of the antenna and less energy reflected back by the antenna. In other words, a smaller S11 parameter indicates that more energy actually enters the antenna and antenna total efficiency is higher. A larger S11 parameter indicates larger return loss of the antenna and lower antenna total efficiency.

It should be noted that in engineering, −6 dB is generally used as a standard value of S11. When S11 of the antenna is less than −6 dB, it may be considered that the antenna can operate normally, or it may be considered that transmission efficiency of the antenna is good.

An antenna polarization direction: At a given space point, electric field strength E (vector) is a function of time t. A vector end point periodically draws a trajectory in space over time. The trajectory is straight and vertical to the ground, and this is referred to as vertical polarization. If the trajectory is parallel to the ground, this is referred to as horizontal polarization. The trajectory is an ellipse or a circle. When the trajectory is observed along a propagation direction, a rotation along a right-hand or clockwise direction over time is referred to as right-hand circular polarization (RHCP), and a rotation along a left-hand or counterclockwise direction over time is referred to as left-hand circular polarization (LHCP).

An antenna axial ratio (AR): In circular polarization, a trajectory drawn periodically by a vector end point of an electric field is an ellipse in space, and a ratio of a major axis to a minor axis of the ellipse is referred to as an axial ratio. The axial ratio is an important performance index of a circularly polarized antenna. The axial ratio indicates purity of circular polarization, and is an important index to measure signal gain differences of the entire electronic device in different directions. When an axis ratio value of circular polarization of the antenna is closer to 1 (a trajectory drawn periodically by the vector end point of the electric field is a circle in space), circular polarization of the antenna is better.

A clearance means a distance between a radiator of an antenna and a metal or electronic component close to the radiator. For example, when a part of a metal frame of an electronic device is used as a radiator of an antenna, the clearance may be a distance between the radiator and a printed circuit board or an electronic component (for example, a camera).

Ground or ground plate may generally mean at least a part of any ground plane, grounding plate or ground metal plane in an electronic device (for example, a mobile phone), or at least a part of any combination of the ground plane, the grounding plate, or a ground component. The “ground” may be used to ground a component in the electronic device. In an embodiment, the “ground” may be a ground plane of a circuit board of the electronic device, or may be a grounding plate formed by a middle frame of the electronic device or a ground metal plane formed by a metal film under a screen of the electronic device. In an embodiment, the circuit board may be a printed circuit board (PCB), for example, an 8-layer, 10-layer, or 12-layer to 14-layer board having 8, 10, 12, 13, or 14 layers of conductive material, or a component that is separated and electrically insulated by a dielectric layer or an insulation layer, for example, glass fiber, polymer, or the like. In an embodiment, the circuit board includes a dielectric substrate, a ground plane, and a wiring layer. The wiring layer and the ground layer are electrically connected through a via. In an embodiment, components such as a display, a touchscreen, an input button, a transmitter, a processor, a memory, a battery, a charging circuit, and a system on chip (SoC) structure may be mounted on or connected to a circuit board, or electrically connected to a wiring layer and/or a ground plane in the circuit board. For example, a radio frequency source is disposed at the wiring layer.

Any of the ground plane, the grounding plate, or the ground metal plane is made of a conductive material. In an embodiment, the conductive material may be any one of the following materials: copper, aluminum, stainless steel, brass, and alloys thereof, copper foil on insulation laminate, aluminum foil on the insulation laminate, gold foil on the insulation laminate, silver-plated copper, silver-plated copper foil on the insulation laminate, silver foil and tin-plated copper on the insulation laminate, cloth impregnated with graphite powder, graphite-coated laminate, copper-plated laminate, brass-plated laminate and aluminum-plated laminate. One of ordinary skilled in the art may understand that the ground plane/grounding plate/ground metal plane may alternatively be made of other conductive materials.

The following describes the technical solution of embodiments of this application with reference to accompanying drawings.

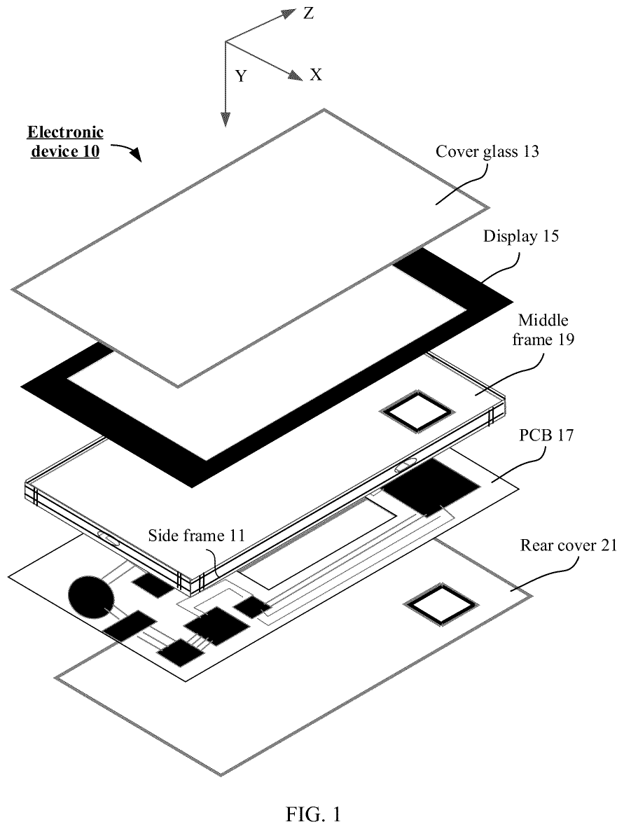

As shown in FIG. 1, an electronic device 10 may include a cover 13, a display/module (display) 15, a printed circuit board (PCB) 17, a middle frame 19, and a rear cover 21. It should be understood that in some embodiments, the cover 13 may be a piece of cover glass, or may be replaced with a cover of another material, for example, a piece of an ultra-thin cover glass or a PET (polyethylene terephthalate) cover.

The cover 13 may be disposed closely in contact with the display module 15, and may be mainly configured to protect the display module 15 against dust.

In an embodiment, the display module 15 may include a liquid crystal display (LCD), a light-emitting diode (LED) display panel, an organic light-emitting semiconductor (OLED) display panel, or the like. This is not limited in embodiments of this application.

The middle frame 19 is mainly used to support the entire electronic device. FIG. 1 shows that the PCB 17 is disposed between the middle frame 19 and the rear cover 21. It should be understood that in an embodiment, the PCB 17 may alternatively be disposed between the middle frame 19 and the display module 15. This is not limited in embodiments of this application. The printed circuit board PCB 17 may be made from a flame-retardant (FR-4) dielectric board, a Rogers dielectric board, a dielectric board in mixed Rogers and FR-4 materials, or the like. Herein, FR-4 is a grade designation for a flame resistant material, and the Rogers dielectric board is a high-frequency board. An electronic component, for example, a radio frequency chip, is carried on the PCB 17. In an embodiment, a metal layer may be disposed on the printed circuit board PCB 17. The metal layer may be used for grounding an electronic component carried on the printed circuit board PCB 17, or may be used for grounding another component, for example, a support antenna or a frame antenna. The metal layer may be referred to as a ground plate, a grounding plate, or a ground plane. In an embodiment, the metal layer may be formed by performing etching on a metal on a surface of any of dielectric board on the PCB 17. In an embodiment, the metal layer used for grounding may be disposed on a side that is of the printed circuit board PCB 17 and that is close to the middle frame 19. In an embodiment, edges of the printed circuit board PCB 17 may be considered as edges of the ground plane of the PCB 17. In an embodiment, the metal middle frame 19 may also be used for grounding the foregoing components. The electronic device 10 may further have another ground plate/grounding plate/ground plane as described above. Details are not described herein again.

The electronic device 10 may further include a battery (not shown in the figure). The battery may be disposed between the middle frame 19 and the rear cover 21, or may be disposed between the middle frame 19 and the display module 15. This is not limited in embodiments of this application. In some embodiments, the PCB 17 is divided into a mainboard and a subboard. The battery may be disposed between the mainboard and the subboard. The mainboard may be disposed between the middle frame 19 and an upper edge of the battery, and the subboard may be disposed between the middle frame 19 and a lower edge of the battery.

The electronic device 10 may further include a frame 11. The frame 11 may be formed from a conductive material, for example, metal. The frame 11 may be disposed between the display module 15 and the rear cover 21, and extends circumferentially around the periphery of the electronic device 10. The frame 11 may have four sides surrounding the display module 15 to help secure the display module 15. In an embodiment, the frame 11 made of a metal material may be directly used as a metal frame of the electronic device 10 to form an appearance of the metal frame, and is applicable to a metal industrial design (ID). In an embodiment, an outer surface of the frame 11 may alternatively be a non-metal material, for example, a plastic frame, to form an appearance of the non-metal frame, and is applicable to a non-metal ID.

The middle frame 19 may include the frame 11. The middle frame 19 including the frame 11 is used as an integral part, and may support electronic components in the entire electronic device. The cover 13 and the rear cover 21 are respectively fitted to the upper and lower edges of the frame, to form a casing or a housing of the electronic device. In an embodiment, the cover 13, the rear cover 21, the frame 11, and/or the middle frame 19 may be collectively referred to as the casing or the housing of the electronic device 10. It should be understood that the “casing or housing” may mean a part or the entire of any one of the cover 13, the rear cover 21, the frame 11, or the middle frame 19, or may mean a part or the entire of any combination of the cover 13, the rear cover 21, the frame 11, or the middle frame 19.

At least a part of the frame 11 on the middle frame 19 may be used as an antenna radiator to receive/transmit a radio frequency signal. There may be a gap between the part that is of the frame and that is used as the radiator and other parts of the middle frame 19, to ensure a good radiation environment for the antenna radiator. In an embodiment, on the middle frame 19, an aperture may be disposed on the part that is of the frame and that is used as the radiator, to facilitate radiation of the antenna.

Alternatively, the frame 11 may not be considered as a part of the middle frame 19. In an embodiment, the frame 11 and the middle frame 19 may be connected to each other to be formed integrally. In another embodiment, the frame 11 may include an inwardly extending protrusion to be connected to the middle frame 19 through a spring plate, a screw, welding, or another manner. The protrusion of the frame 11 may be further configured to receive a feed signal, so that the at least part of the frame 11 is used as the radiator of the antenna to receive/transmit the radio frequency signal. There may be a gap 42 between the part that is of the frame and that is used as the radiator and the middle frame 30, to ensure a good radiation environment for the antenna radiator. In this way, the antenna has a good signal transmission function.

The rear cover 21 may be a rear cover made of a metal material, a rear cover made of a non-conductive material, for example, a glass rear cover or a plastic rear cover, or a rear cover made of both a conductive material and a non-conductive material.

The antenna of the electronic device 10 may alternatively be disposed in the frame 11. When the frame 11 of the electronic device 10 is made of a non-conductive material, the antenna radiator may be located in the electronic device 10 and disposed along the frame 11. For example, the antenna radiator is disposed close to the frame 11, to minimize a volume occupied by the antenna radiator. The antenna radiator is disposed closer to the outside of the electronic device 10, to implement better signal transmission effect. It should be noted that, that the antenna radiator is disposed close to the frame 11 means that the antenna radiator may be disposed closely in contact with the frame 11, or may be disposed near the frame 11. For example, there may be a small slot between the antenna radiator and the frame 11.

Alternatively, the antenna of the electronic device 10 may be disposed in the housing, for example, a support antenna or a millimeter wave antenna (not shown in FIG. 1). A clearance of the antenna disposed in the housing may be obtained through a slit/hole on any one of the middle frame, and/or the frame, and/or the rear cover, and/or the display, or may be obtained through a non-conductive slit/aperture formed between any two or three of the middle frame, frame, rear cover and the display. Clearance settings of the antenna can ensure radiation performance of the antenna. It should be understood that the clearance of the antenna may be a non-conductive region formed by any conductive component in the electronic device 10, and the antenna radiates a signal to external space through the non-conductive region. In an embodiment, a form of the antenna 40 may be a flexible printed circuit (FPC)-based antenna form, a laser-direct-structuring (LDS)-based antenna form, or a microstrip disk antenna (MDA), or the like. In an embodiment, the antenna may alternatively use a transparent structure embedded in the screen of the electronic device 10, so that the antenna is a transparent antenna element embedded in the screen of the electronic device 10.

FIG. 1 schematically shows only some components included in the electronic device 10. Actual shapes, actual sizes, and actual structures of the components are not limited by FIG. 1.

It should be understood that in embodiments of this application, it may be considered that a surface on which the display of the electronic device is located is a front surface, a surface on which the rear cover is located is a back surface, and a surface on which the frame is located is a side surface.

It should be understood that in embodiments of this application, it is considered that when a user holds the electronic device (the user usually holds the electronic device upright and faces the screen), orientations of the electronic device include a top part, a bottom part, a left part, and a right part. It should be understood that in embodiments of this application, it is considered that when a user holds the electronic device (the user usually holds the electronic device upright and faces the screen), orientations of the electronic device include a top part, a bottom part, a left part, and a right part.

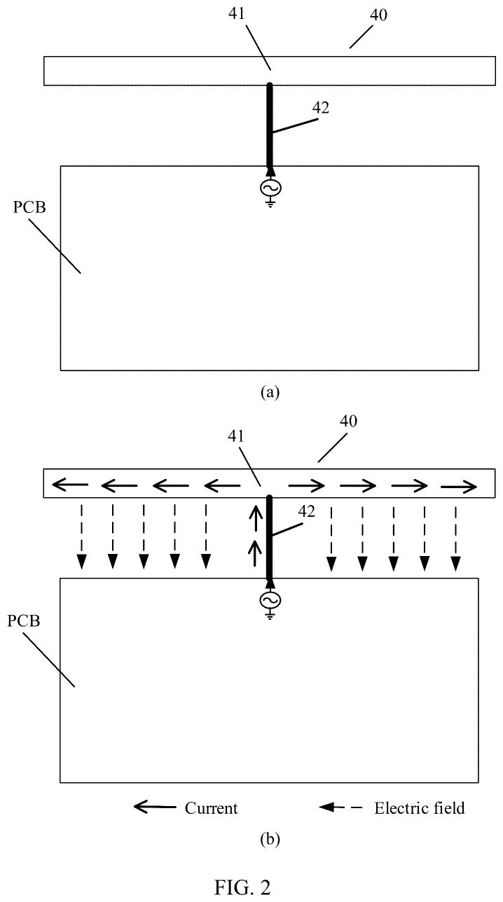

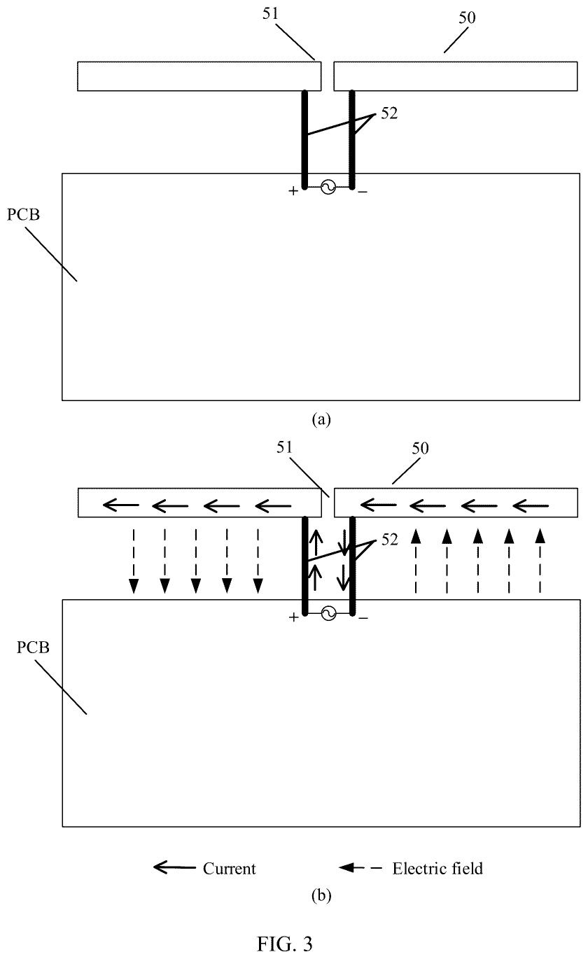

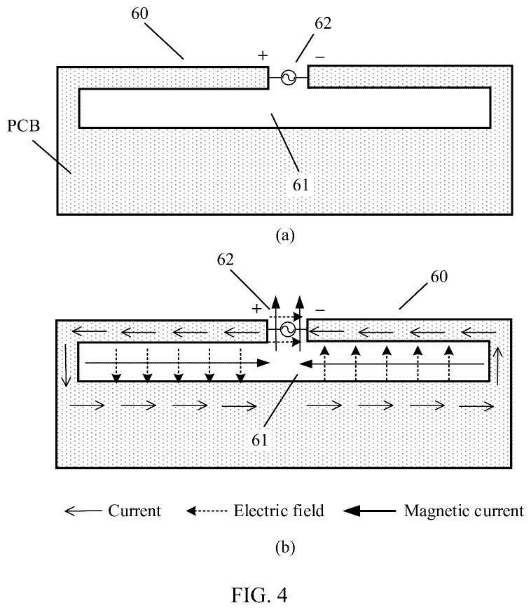

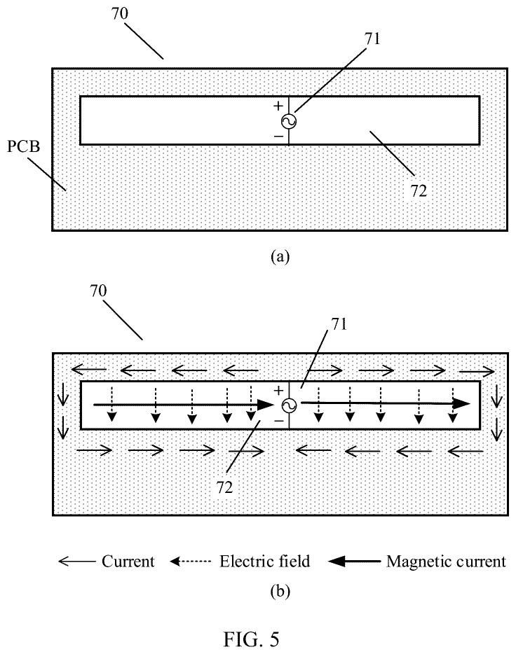

First, this application relates to four antenna modes as described with reference to FIG. 2 to FIG. 5. FIG. 2 is a diagram of a structure of a common-mode of a linear antenna and distributions of a corresponding current and electric field according to the application. FIG. 3 is a diagram of a structure of a differential-mode of a linear antenna and distributions of a corresponding current and electric field according to the application. FIG. 4 is a diagram of a structure of a common-mode of a slot antenna and distributions of a corresponding current, electric field, and magnetic current according to the application. FIG. 5 is a diagram of a structure of another differential-mode of a slot antenna and distributions of a corresponding current, electric field, and magnetic current according to the application.

### 1. Common Mode (CM) of a Linear Antenna

(a) in FIG. 2 shows that a radiator of a linear antenna 40 is connected to the ground (for example, a ground plate, which may be a PCB) through a feeder line 42. The linear antenna 40 is connected to a feed unit (not shown in the figure) at a middle position 41, and uses symmetrical feed. The feed unit may be connected to the middle position 41 of the linear antenna 40 through the feeder line 42. It should be understood that symmetrical feed may be understood as that one end of the feed unit is connected to the radiator, and the other end is grounded. A connection point (feed point) between the feed unit and the radiator is located in the center of the radiator, and the center of the radiator may be, for example, a midpoint of an integral structure, or a midpoint of an electrical length (or a region within a range around the midpoint).

The middle position 41 of the linear antenna 40 may be, for example, the middle position 41, the geometric center of the linear antenna, or a midpoint of the electrical length of the radiator. For example, a connection position between the feeder line 42 and the linear antenna 40 covers the middle position 41.

(b) in FIG. 2 shows distributions of a current and an electric field of the linear antenna 40. As shown in (b) in FIG. 2, the current is symmetrically distributed on two sides of the middle position 41, for example, being distributed in opposite directions. The electric field is distributed in a same direction on two sides of the middle position 41. As shown in (b) in FIG. 2, the current is distributed in a same direction at the feeder line 42. When the current is distributed in a same direction at the feeder line 42, the type of feed shown in (a) in FIG. 2 may be referred to as CM feed of the linear antenna. When the current is symmetrically distributed on two sides of the connection position between the radiator and the feeder line 42, the mode of the linear antenna shown in (b) in FIG. 2 may be referred to as a CM mode of the linear antenna (or may be referred to as a CM linear antenna for short). The current and the electric field shown in (b) in FIG. 2 may be respectively referred to as a CM-mode current and a CM-mode electric field of the linear antenna.

The CM-mode current and CM-mode electric field of the linear antenna are generated by using two stubs (for example, two horizontal stubs) on two sides of the middle position 41 of the linear antenna 40 as antennas operating in a quarter-wavelength mode. The current is strong at the middle position 41 of the linear antenna 40 and is weak at two ends of the linear antenna 40. The electric field is weak at the middle position 41 of the linear antenna 40 and is strong at two ends of the linear antenna 40.

### 2. Differential Mode (DM) Mode of the Linear Antenna

(a) in FIG. 3 shows that two radiators of a linear antenna 50 are connected to the ground (for example, a ground plate, which may be a PCB) through feeder lines 52. The linear antenna 50 is connected to a feed unit at a middle position 51 between the two radiators, and uses anti-symmetrical feed. One end of the feed unit is connected to one of the radiators through the feeder line 52, and the other end of the feed unit is connected to the other radiator through the feeder line 52. The middle position 51 may be the geometric center of the linear antenna, or a slot formed between the radiators.

It should be understood that the “central anti-symmetrical feed” in this application may be understood as that positive and negative electrodes of the feed unit are respectively connected to two connection points near the midpoint of the radiators. Signals output from the positive and negative electrodes of the feed unit have the same amplitude but reverse phases. For example, a phase difference is 180°±10°.

(b) in FIG. 3 shows distributions of a current and an electric field of the linear antenna 50. As shown in (b) in FIG. 3, the current is asymmetrically distributed on two sides of the middle position 51 of the linear antenna 50, for example, being distributed in a same direction. The electric field is distributed in opposite directions on two sides of the middle position 51. As shown in (b) in FIG. 3, the current is distributed in opposite directions at the feeder lines 52. When the current is distributed in opposite directions at the feeder lines 52, the type of feed shown in (a) in FIG. 3 may be referred to as DM feed of the linear antenna. When the current is asymmetrically distributed on two sides of a connection position between the radiator and the feeder line 52 (for example, being distributed in the same direction), the mode of the linear antenna shown in (b) in FIG. 3 may be referred to as a DM mode of the linear antenna (or may be referred to as a DM linear antenna for short). The current and the electric field shown in (b) in FIG. 3 may be respectively referred to as a DM-mode current and a DM-mode electric field of the linear antenna.

The DM-mode current and DM-mode electric field of the linear antenna are generated by using the entire linear antenna 50 as an antenna operating in a half-wavelength mode. The current is strong at the middle position 51 of the linear antenna 50 and is weak at two ends of the linear antenna 50. The electric field is weak at the middle position 51 of the linear antenna 50 and is strong at two ends of the linear antenna 50.

It should be understood that a radiator of a linear antenna may be understood as a metal mechanical piece generating radiation. The linear antenna may include one radiator as shown in FIG. 2, or may include two radiators as shown in FIG. 3. A quantity of radiators may be adjusted based on an actual design or production requirement. For example, the CM mode of the linear antenna may alternatively use two radiators as shown in FIG. 3. Two ends of the two radiators are disposed opposite to each other and are spaced by a slot. A symmetrical feed manner is used at the two ends close to each other. For example, effect similar to that of the antenna structure shown in FIG. 2 may also be obtained by respectively feeding signals of a same source into the two ends that are of the two radiators and that are close to each other. Correspondingly, the DM mode of the linear antenna, may alternatively use one radiator as shown in FIG. 2. Two feed points are disposed at the middle position of the radiator, and an anti-symmetrical feed manner is used. For example, effect similar to that of the antenna structure shown in FIG. 3 may also be obtained by separately feeding signals of a same amplitude but reverse phases into the two symmetrical feed points on the radiator.

### 3. CM Mode of a Slot Antenna

A slot antenna 60 shown in (a) in FIG. 4 may be formed by hollowing out a gap or a slot 61 in a radiator of the slot antenna, or may be formed by enclosing the gap or the slot 61 by the radiator of the slot antenna and the ground (for example, a ground plate, which may be a PCB). The slot 61 may be disposed on the ground plate. An opening 62 is disposed on one side of the slot 61, and the opening 62 may be disposed at a middle position of the side. The middle position of the side of the slot 61 may be, for example, the geometric midpoint of the slot antenna, or a midpoint of an electrical length of the radiator. For example, a region in which the opening 62 is disposed on the radiator covers the middle position of the side. A feed unit may be connected at the opening 62, and anti-symmetrical feed is used. It should be understood that the “anti-symmetrical feed” may be understood as that positive and negative electrodes of the feed unit are respectively connected to two ends of the radiator. Signals output from the positive and negative electrodes of the feed unit have the same amplitude but reverse phases. For example, a phase difference is 180°±10°.

(b) in FIG. 4 shows distributions of a current, an electric field, and a magnetic current of the slot antenna 60. As shown in (b) in FIG. 4, the current is distributed over a conductor (for example, the ground plate and/or a radiator 60) around the slot 61 in a same direction around the slot 61. The electric field is distributed in opposite directions on two sides of the middle position of the slot 61. The magnetic current is distributed in opposite directions on two sides of the middle position of the slot 61. As shown in (b) in FIG. 4, the electric field is in a same direction at the opening 62 (for example, a feed position), and the magnetic current is in a same direction at the opening 62 (for example, the feed position). When the magnetic current is in the same direction at the opening 62 (the feed position), the type of feed shown in (a) in FIG. 4 may be referred to as CM feed of the slot antenna. When the current is asymmetrically distributed over a radiator between two sides of the opening 62 (for example, being distributed in a same direction), or when the current is distributed over the conductor around the slot 61 in a same direction around the slot 61, the slot antenna mode shown in (b) in FIG. 4 may be referred to as a CM mode of the slot antenna (or may be referred to as a CM slot antenna or a CM slot antenna for short). The electric field, the current, and the magnetic current shown in (b) in FIG. 4 may be referred to as a CM-mode electric field, a CM-mode current, and a CM-mode magnetic current of the slot antenna.

The CM-mode current and the CM-mode electric field of the slot antenna are generated by using slot antenna parts at two sides of the middle position of the slot antenna 60 as antennas operating in a half-wavelength mode. The magnetic field is weak at the middle position of the slot antenna 60 and is strong at two ends of the slot antenna 60. The electric field is strong at the middle position of the slot antenna 60 and is weak at two ends of the slot antenna 60.

### 4. DM Mode of the Slot Antenna

A slot antenna 70 shown in (a) in FIG. 5 may be formed by hollowing out a gap or a slot 72 in a radiator of the slot antenna, or may be formed by enclosing the gap or the slot 72 by the radiator of the slot antenna and the ground (for example, a ground plate, which may be a PCB). The slot 72 may be disposed on the ground plate. A feed unit may be connected at a middle position 71 of the slot 72, and symmetrical feed is used. It should be understood that symmetrical feed may be understood as that one end of the feed unit is connected to the radiator, and the other end is grounded. A connection point (feed point) between the feed unit and the radiator is located in the center of the radiator, and the center of the radiator may be, for example, a midpoint of an integral structure, or a midpoint of an electrical length (or a region within a range around the midpoint). A middle position on one side of the slot 72 is connected to the positive electrode of the feed unit, and a middle position on the other side of the slot 72 is connected to the negative electrode of the feed unit. The middle position on the side of the slot 72 may be, for example, the middle position of the slot antenna 60/the middle position of the ground, for example, a geometric midpoint of the slot antenna, or a midpoint of an electrical length of the radiator. For example, a connection position between the feed unit and the radiator covers a middle position 51 on the side.

(b) in FIG. 5 shows distributions of a current, an electric field, and a magnetic current of the slot antenna 70. As shown in (b) in FIG. 5, the current is distributed over a conductor (for example, the ground plate and/or the radiator 60) around the slot 72 around the slot 72, and is distributed in opposite directions on two sides of the middle position of the slot 72. The electric field is distributed in a same direction on two sides of the middle position 71. The magnetic current is distributed in a same direction on two sides of the middle position 71. The magnetic current is distributed in opposite directions at the feed unit (not shown in the figure). When the magnetic current is distributed in opposite directions at the feed unit, the type of feed shown in (a) in FIG. 5 may be referred to as DM feed of the slot antenna. When the current is symmetrically distributed on two sides of the connection position between the feed unit and the radiator (for example, being distributed in opposite directions), or when the current is symmetrically distributed around the slot 71 (for example, being distributed in opposite directions), the slot antenna mode shown in (b) in FIG. 5 may be referred to as a DM mode of the slot antenna (or may be referred to as a DM slot antenna or a DM slot antenna for short). The electric field, the current, and the magnetic current shown in (b) in FIG. 5 may be referred to as a DM-mode electric field, a DM-mode current, and a DM-mode magnetic current of the slot antenna.

The DM-mode current and the DM-mode electric field of the slot antenna are generated by using the entire slot antenna 70 as an antenna operating in a one-time wavelength mode. The current is weak at the middle position of the slot antenna 70 and is strong at two ends of the slot antenna 70. The electric field is strong at the middle position of the slot antenna 70 and is weak at two ends of the slot antenna 70.

In the antenna field, an antenna operating in the CM mode and an antenna operating in the DM mode have high isolation. In addition, frequency bands of the antennas in the CM mode and in the DM mode are usually for single-mode resonance, and thus cannot cover a plurality of frequency bands required for communication. In particular, in an electronic device, there is less space for an antenna structure. For a MIMO system, a single antenna structure needs to cover the plurality of frequency bands. Therefore, antennas that resonate in multi-mode and have high isolation hold significant research and practical value

It should be understood that a radiator of a slot antenna may be understood as a metal mechanical piece (for example, including a part of a ground plate) generating radiation. The radiator may include an opening shown in FIG. 4, or may alternatively be a complete ring shown in FIG. 5. The radiator may be adjusted based on an actual design or production requirement. For example, the CM mode of the slot antenna may alternatively use a complete ring-shaped radiator shown in FIG. 5. Two feed points are disposed at the middle position of the radiator on one side of the slot 61, and an anti-symmetrical feed manner is used. For example, effect similar to that of the antenna structure shown in FIG. 4 may also be obtained by separately feeding signals of a same amplitude but reverse phases into two ends of a position in which the opening is originally disposed. Correspondingly, the DM mode of the slot antenna may alternatively use a radiator including an opening as shown in FIG. 4. A symmetrical feed manner is used at two ends of the opening position. For example, effect similar to that of the antenna structure shown in FIG. 5 may also be obtained by respectively feeding signals of a same feed source into the two ends of the radiator at two sides of the opening.

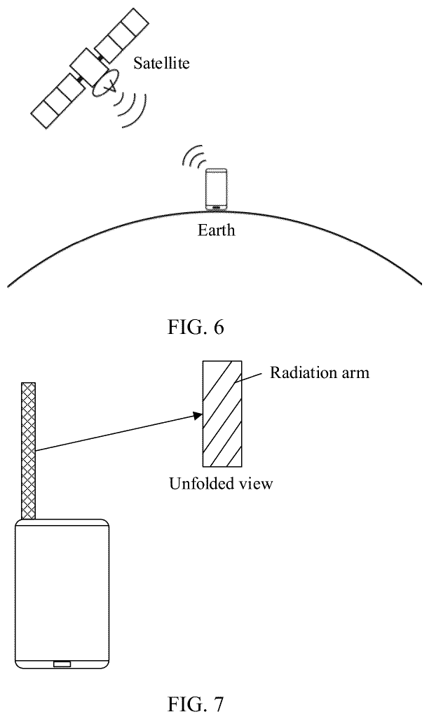

FIG. 6 is a diagram of a usage scenario of a circularly polarized antenna according to an embodiment of this application.

As shown in FIG. 6, in a satellite navigation or communication system, compared with a linearly polarized antenna, a circularly polarized antenna has some unique advantages. For example, a polarization rotation (commonly referred to as “Faraday rotation”) occurs when linearly polarized waves pass through the ionosphere, and circularly polarized waves have rotational symmetry and can resist the Faraday rotation. Therefore, the circularly polarized antenna is generally used as a transmit or receive antenna for satellite navigation or communication. In addition, in the satellite navigation or communication system, if the conventional linearly polarized antenna is used to receive circularly polarized waves from a satellite, half of energy is lost due to polarization mismatch. In addition, the circularly polarized antenna is insensitive to directions of a transceiver antenna.

For example, the satellite navigation or communication system may be a BeiDou satellite system. An operating frequency band of the BeiDou satellite system may include an L frequency band (1610 MHz to 1626.5 MHz), an S frequency band (2483.5 MHz to 2500 MHz), a B1 frequency band (1559 Hz to 1591 MHz), a B2 frequency band (1166 MHz to 1217 MHz), and a B3 frequency band (1250 MHz to 1286 MHz).

FIG. 7 is a diagram of a circularly polarized antenna according to an embodiment of this application.

For a satellite phone, an external circularly polarized antenna is usually used, and an antenna structure is shown in FIG. 7. The external circularly polarized antenna includes four radiation arms printed on an outer wall of a dielectric cylinder. The four radiation arms use a circularly polarized feed network, and the four radiation arms perform feeding at phase differences of [0°, 90°, 180°, and 270° ] in sequence, to implement a radiation pattern of circular polarization of wide beams.

However, for an electronic device (for example, the mobile phone shown in FIG. 1), the external circularly polarized antenna shown in FIG. 7 is of an excessively large size, and built-in integration of the antenna in the electronic device cannot be implemented. In addition, because a plurality types of electronic components need to be disposed in the electronic device, a clearance of the antenna is generally very small (for example, the clearance of the antenna is less than or equal to 2 mm, or less than or equal to 1.5 mm). It is difficult to reserve large space for implementing circular polarization of the antenna.

Embodiments of this application provide an electronic device, including an antenna structure. The antenna structure is disposed in the electronic device in a built-in manner. A metal frame is used as a radiator, to implement circular polarization in a small-clearance environment.

For an ideal circularly polarized antenna, two prerequisites for generating circular polarization are as follows: (1) There is a group of antenna elements with orthogonal polarization manners, and amplitudes of radiation generated by the antenna elements are approximately the same. (2) There is about a 90-degree phase difference between the antenna elements.

The orthogonal polarization manners may be understood as that an inner product of radiation generated between the antenna elements is zero in a far field (integral orthogonality) The integral orthogonality may be understood as that an electric field in which the antenna element generates resonance satisfies the following formula in the far field:

$$\int \int {E}_{1} ( θ , φ ) \cdot {E}_{2} ( θ , φ ) d θ d φ = 0.$$

E₁(θ,φ) is a far-field electric field corresponding to resonance generated by a first antenna element, and E₂(θ,φ) is a far-field electric field corresponding to resonance generated by a second antenna element. In a three-dimensional coordinate system, θ is an angle between a radiation direction and a z axis, and φ is an angle between the radiation direction and an x axis in an xoy plane.

FIG. 2 to FIG. 5 respectively show the CM mode of the linear antenna, the DM mode of the linear antenna, the CM mode of the slot antenna, and the DM mode of the slot antenna. In the current distributions shown in FIG. 2 to FIG. 5, the combination of the CM mode of the linear antenna and the DM mode of the linear antenna, the combination of the CM mode of the slot antenna and the DM mode of the slot antenna, the combination of the CM mode of the linear antenna and the CM mode of the slot antenna, and the combination of the DM mode of the linear antenna and the DM mode of the slot antenna have polarization mode orthogonality. Therefore, a combination structure of the CM mode and the DM mode can be used as a basic unit for designing a circularly polarized antenna. For example, frequencies of first resonance and second resonance that are generated by an antenna structure fall within a range, circular polarization may be implemented based on a frequency band between the frequency of the first resonance and the frequency of the second resonance.

It should be understood that when the linear antenna or the slot antenna uses an offset central feed manner, both the CM mode and the DM mode of the linear antenna or both the CM mode and the DM mode of the slot antenna may be simultaneously excited. The “offset central feed” in this application may be understood as offset feed (side feed). In an embodiment, a connection point (feed point) between a feed unit and the radiator deviates from a center of symmetry (virtual axis) of the radiator. In an embodiment, a connection point (feed point) between a feed unit and the radiator is located on a tail end of the radiator and is located in a region within a distance of a quarter of an electrical length to an end point of the tail end of the radiator (excluding a position at the quarter of the electrical length), or may be located in a region within a distance of one-eighth of the first electrical length to the end point of the radiator. The electrical length may be an electrical length of the radiator.

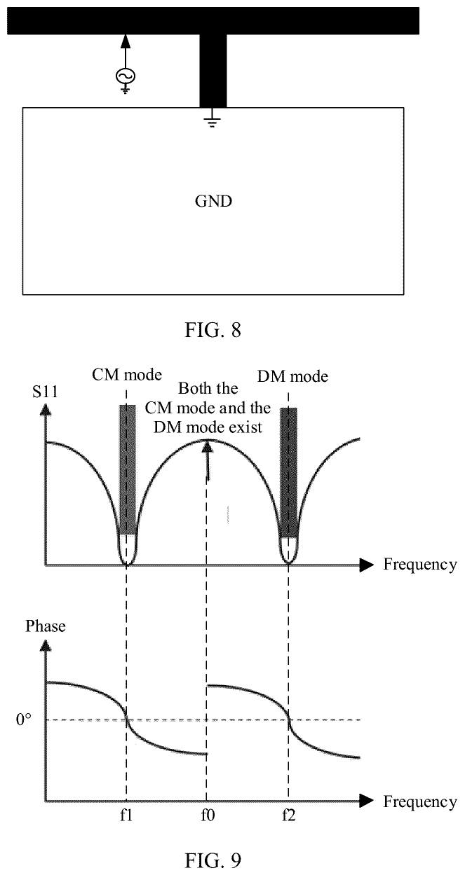

For brevity of description, an example in which a linear antenna uses the offset central feed manner to simultaneously excite both a CM mode and a DM mode of the linear antenna is used for description, as shown in FIG. 8.

FIG. 9 is a diagram of a simulation result of the antenna structure shown in FIG. 8.

As shown in FIG. 9, when a feed unit feeds an electrical signal, the antenna may respectively generate resonance at a frequency f1 in the CM mode and resonance at a frequency f2 in the DM mode. Generally, the resonance generated in the CM mode has a lower resonance frequency.

A frequency f0 exists between the frequency of the resonance generated in the CM mode and the frequency of the resonance generated in the DM mode. At the frequency f0, both the CM mode and the DM mode exist, and an amplitude of a radiation component corresponding to the CM mode is approximately the same as an amplitude of a radiation component corresponding to the DM mode.

In addition, at the frequency f0, a phase of the radiation component corresponding to the CM mode is −φ1, and a phase of the radiation component corresponding to the DM mode is +φ2. Therefore, when a frequency difference between the frequency of the resonance generated in the CM mode and the frequency of the resonance generated in the DM mode is adjusted to a proper range, φ1+φ2≈90° may be met. In other words, a phase difference between the CM mode and the DM mode is about 90°.

Therefore, at the frequency f0, a condition in which the antenna structure shown in FIG. 8 generates circular polarization may be met.

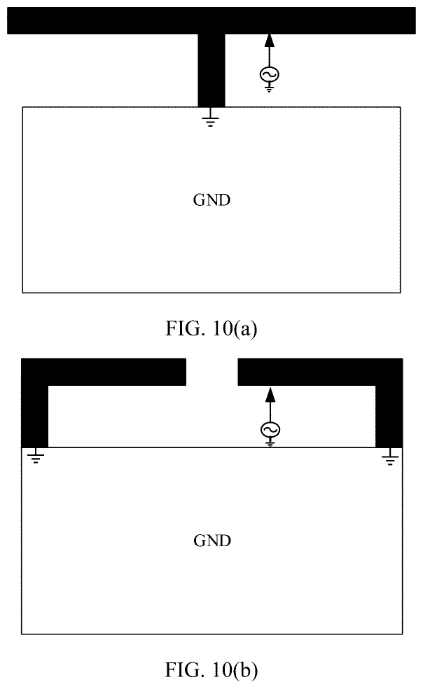

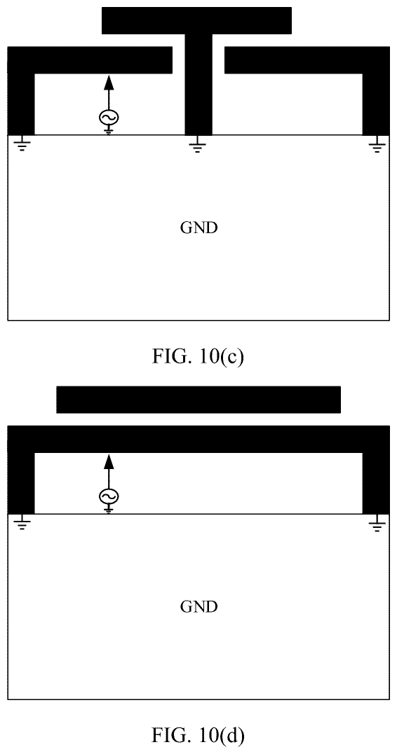

It should be understood that in FIG. 8, only the combination of the CM mode of the linear antenna and the DM mode of the linear antenna (as shown in FIG. 10(a)) is used as an example for description. The combination of the CM mode of the slot antenna and the DM mode of the slot antenna (as shown in FIG. 10(b)), the combination of the CM mode of the linear antenna and the CM mode of the slot antenna (as shown in FIG. 10(c)), and the combination of the DM mode of the linear antenna and the DM mode of the slot antenna (as shown in FIG. 10(d)) may also meet a corresponding condition.

As shown in FIG. 10(a) to FIG. 10(d), in the combination of the CM mode of the linear antenna and the CM mode of the slot antenna and the combination of the DM mode of the linear antenna and the DM mode of the slot antenna, feeding may be performed on one antenna element. To ensure good coupling between the antenna elements in the combination, a distance between a projection of a radiator of one antenna element in a first direction and a projection of a radiator of the other antenna element in the first direction is less than 10 mm. The first direction is a direction perpendicular to a ground plate.

In the combination of the CM mode of the linear antenna and the CM mode of the slot antenna, the linear antenna may include a ground point to form a T-shaped antenna. A slot may be disposed on a radiator of the slot antenna, so that an open slot is formed between the radiator and the ground plate. In the combination of the DM mode of the linear antenna and the DM mode of the slot antenna, the linear antenna may not include a ground point. Alternatively, no slot is disposed on a radiator of the slot antenna, so that a closed slot is formed between the radiator and the ground plate.

In an embodiment, at the frequency f0, the phase of the radiation component corresponding to the CM mode and the phase of the radiation component corresponding to the DM mode may be adjusted, so that circular polarization may be adjusted to RHCP or LHCP.

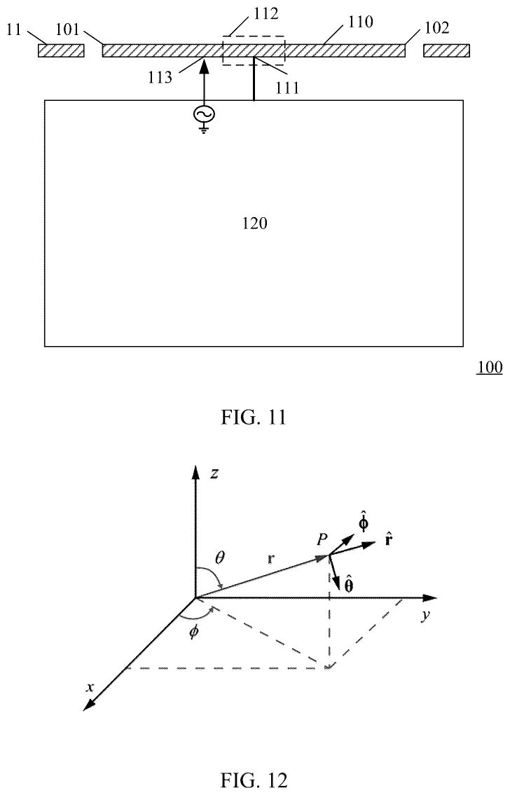

FIG. 11 is a diagram of an antenna structure 100 according to an embodiment of this application.

As shown in FIG. 11, the antenna structure 100 may include a radiator 110 and a ground plate 120.

The radiator 110 includes a ground point 111. The radiator 110 is grounded at the ground point 111 through the ground plate 120. The antenna structure 100 generates first resonance and second resonance. A ratio of a frequency of the first resonance to a frequency of the second resonance is greater than 1 and less than or equal to 1.5. An operating frequency band of the antenna structure 100 includes a first frequency band, and a frequency in the first frequency band is between the frequency of the first resonance and the frequency of the second resonance. An axial ratio of circular polarization of the antenna structure 100 in the first frequency band is less than or equal to 10 dB.

It should be understood that a ratio of a frequency of the first resonance to a frequency of the second resonance is greater than 1 and less than or equal to 1.5 may be understood as that a ratio of a resonance frequency of the first resonance to a resonance frequency of the second resonance is greater than 1 and less than or equal to 1.5, or a ratio of a center frequency in the first frequency band to a center frequency in a second frequency band is greater than 1 and less than or equal to 1.5. That a frequency in the first frequency band is between the frequency of the first resonance and the frequency of the second resonance may be understood as that a frequency in the first frequency band is greater than or equal to the frequency of the second resonance and is less than or equal to the frequency of the first resonance.

In the antenna structure 100 shown in FIG. 11, the first resonance and the second resonance are generated in a DM mode and a CM mode. Generally, a frequency of the resonance generated in the DM mode is higher than a frequency of the resonance generated in the CM mode. For brevity of description, in an embodiment, only an example in which the frequency of the resonance generated in the DM mode is higher than the frequency of the resonance generated in the CM mode is used for description. In actual application, the frequency of the resonance generated in the DM mode may be adjusted to be lower than the frequency of the resonance generated in the CM mode.

The antenna structure 100 generates the first resonance in the DM mode, and generates the second resonance in the CM mode. A frequency by which the first resonance is spaced from the second resonance is adjusted, so that the antenna structure 100 may have both the CM mode and the DM mode in the first frequency band with frequencies between the frequency of the first resonance and the frequency of the second resonance. In the first frequency band, the antenna structure 100 may implement circular polarization (the axial ratio of circular polarization is less than or equal to 10 dB) in the CM mode and the DM mode with orthogonal polarizations.

In an embodiment, the frame 11 has a first position 101 and a second position 102, gaps are respectively disposed on the frame 11 at the first position 101 and the second position 102, and a first frame between the first position 101 and the second position 102 is used as the radiator 110. It should be understood that the antenna structure 100 may be used in an electronic device. A first frame in the conductive frame 11 of the electronic device is used as the radiator 110, and the antenna structure 100 can still implement circular polarization in a small-clearance environment (the clearance is less than a first threshold, where the first threshold may be, for example, 1 mm, 1.5 mm, or 2 mm).

In an embodiment, in the first frequency band, a difference between a first gain generated by the antenna structure 100 and a second gain generated by the antenna structure 100 is less than 10 dB, so that the antenna structure 100 has good circular polarization. The first gain is a gain of a pattern generated by the antenna structure 100 in a first polarization direction. The second gain is a gain of a pattern generated by the antenna structure 100 in a second polarization direction. The first polarization direction is orthogonal to the second polarization direction. The first polarization direction may be a polarization direction corresponding to the CM mode, and the second polarization direction may be a polarization direction corresponding to the DM mode.

It should be understood that as shown in FIG. 12, in three-dimensional space, for any point P, an origin O is used as a circle center, and a distance from the origin O to the point P is used as a radius to form a circle. theta polarization is polarization along a tangential direction of a meridian of the circle in which the point P is located. phi polarization is polarization along a tangential direction of a weft of the circle in which the point P is located. abs polarization is an integration of theta polarization and phi polarization, where the abs polarization is total polarization, and theta polarization and phi polarization are two polarization components of the total polarization. The first polarization and the second polarization may respectively be theta polarization and phi polarization.

In an embodiment, in the first frequency band, a difference between a first phase generated by the antenna structure 100 and a second phase generated by the antenna structure 100 is greater than 25° and less than 155° (90° 65°), so that the antenna structure 100 has good circular polarization. The first phase is a phase of radiation generated by the antenna structure 100 in the first polarization direction. The second phase is a phase of radiation generated by the antenna structure 100 in the second polarization direction. The first polarization direction is orthogonal to the second polarization direction. The first polarization direction may be a polarization direction corresponding to the CM mode, and the second polarization direction may be a polarization direction corresponding to the DM mode.

In an embodiment, the ratio of the frequency of the first resonance to the frequency of the second resonance is greater than or equal to 1.2 and less than or equal to 1.35, so that the antenna structure 100 has better circular polarization.

In an embodiment, the ground point 111 may be disposed in a central region 112 of the radiator 110, so that the antenna structure 100 forms a symmetrical T-shaped antenna. The central region 112 may be considered as a region within a distance to a geometric center or a center of an electrical length of the radiator 110. For example, the central region 112 may be a region within 5 mm to the geometric center of the radiator 110, may be a region within three-eighths to five-eighths of a physical length of the radiator 110, or may be a region within three-eighths to five-eighths of the electrical length of the radiator 110.

In an embodiment, the antenna structure 100 operates in the DM mode, the current on the radiator 110 of the antenna structure 100 is asymmetrically distributed along the ground point (for example, being distributed in a same direction), and the antenna structure 100 generates the first resonance. The antenna structure 100 operates in the CM mode, the current on the radiator 110 of the antenna structure 100 is symmetrically distributed along the ground point (for example, being distributed in opposite directions), and the antenna structure 100 generates the second resonance.

In an embodiment, because the antenna structure 100 has both the CM mode and the DM mode in the first frequency band, the current on the radiator 110 presents different distribution states at different moments in a cycle. For example, the current on the radiator 110 is symmetrically distributed along the ground point 111 at a first moment (a moment corresponding to the CM mode), and the current on the radiator 110 is asymmetrically distributed along the ground point 111 at a second moment (a moment corresponding to the DM mode).

In an embodiment, the radiator 110 further includes a feed point 113. The feed point 113 is disposed between the ground point 111 and the first position 101, and no feed point is disposed between the ground point 111 and the second position 102. It should be understood that the antenna structure 100 uses offset central feed(offset feed/side feed). The antenna structure 100 may generate the resonance in both the CM mode and the DM mode. The structure of the antenna structure 100 is simple, and is easy for performing a layout on the inside of the electronic device.

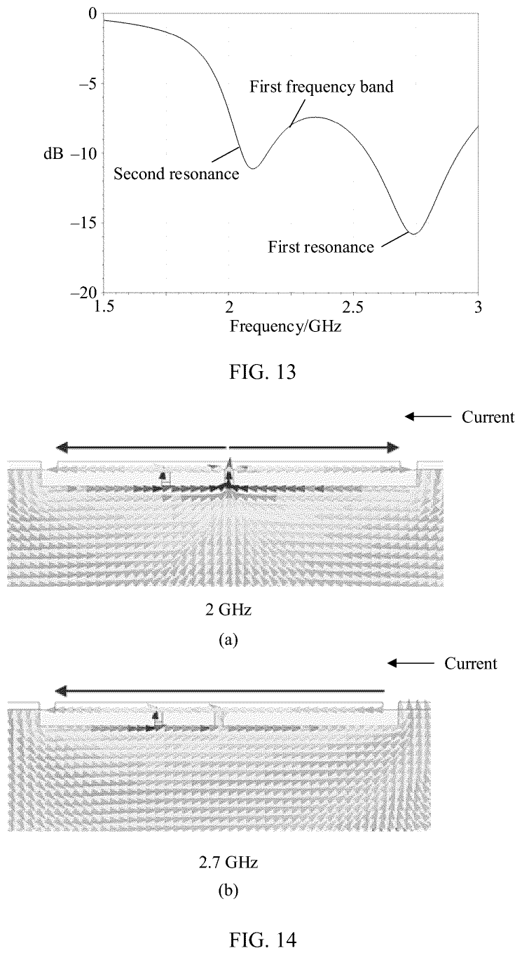

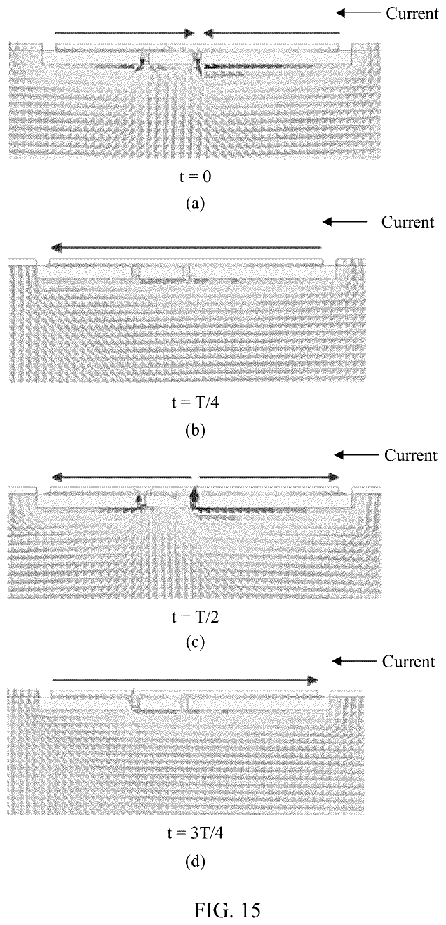

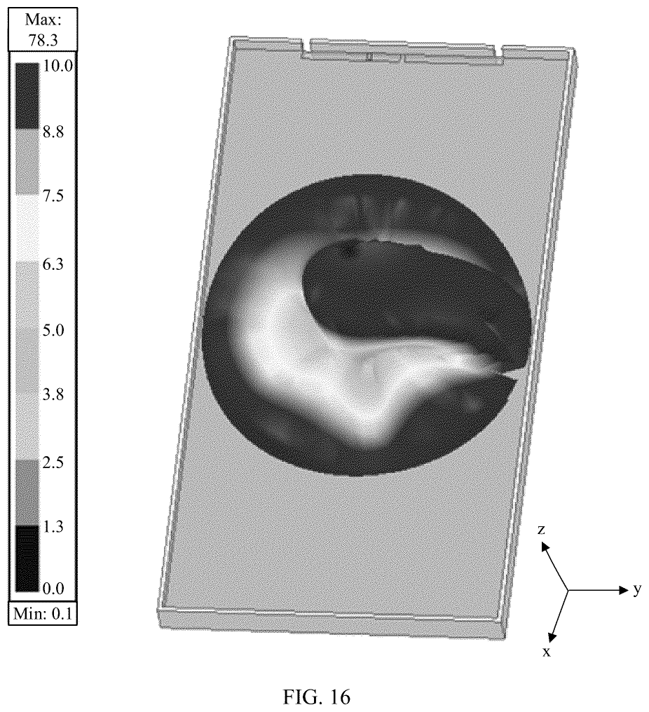

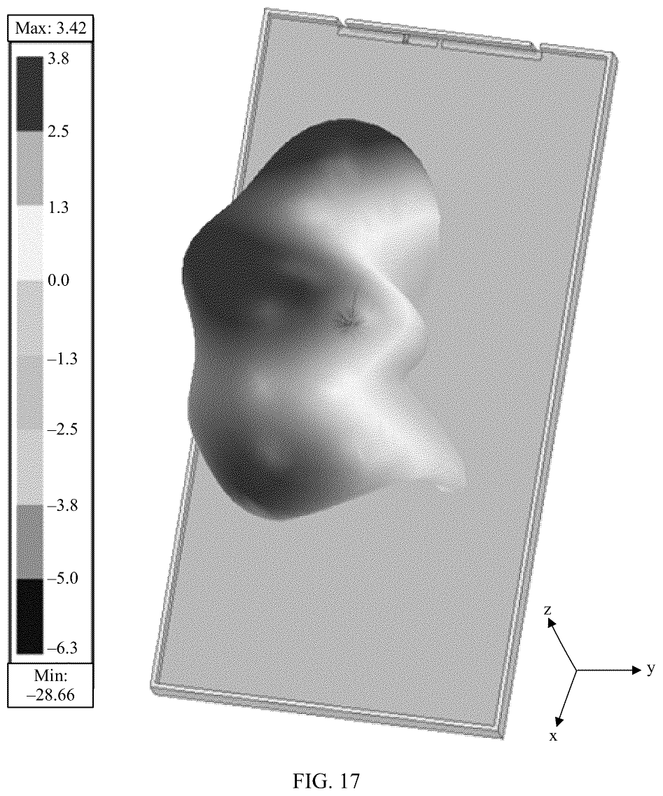

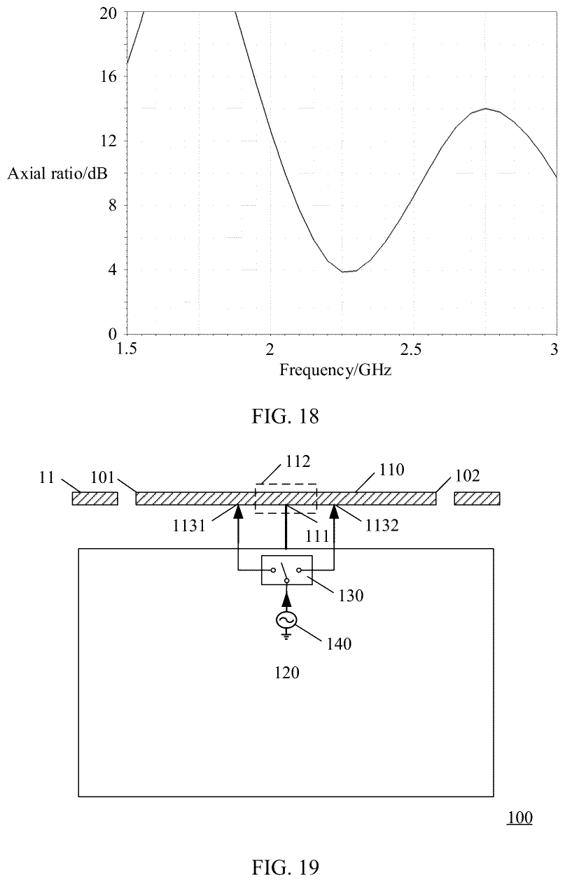

FIG. 13 to FIG. 18 are diagrams of simulation results of the antenna structure shown in FIG. 11. FIG. 13 is an S-parameter diagram of the antenna structure 100 shown in FIG. 11. FIG. 14 is a current distribution diagram of the antenna structure 100 shown in FIG. 11 at 2 GHz and 2.7 GHz. FIG. 15 is an electric field distribution diagram of the antenna structure shown in FIG. 11 at different moments in a cycle. FIG. 16 is an axial ratio pattern of circular polarization of the antenna structure shown in FIG. 11. FIG. 17 is a gain pattern of the antenna structure shown in FIG. 11. FIG. 18 is a curve graph of axial ratios of circular polarization of the antenna structure shown in FIG. 11.

It should be understood that in an embodiment of this application, an example in which a size of the ground plate 120 in the antenna structure 100 shown in FIG. 11 is 150 mm×75 mm, and a clearance of the antenna structure 100 is 1 mm is used for description. For brevity of the discussion, the same simulation environment is also used in the following embodiments.

As shown in FIG. 13, that S11<−6 dB is used as a boundary. The antenna structure generates two resonance points at the second resonance (near 2 GHz) and the first resonance (near 2.7 GHz).

At the 2 GHz (the second resonance), the antenna structure operates in the CM mode, and the current on the radiator is symmetrically distributed along the ground point, as shown in (a) in FIG. 14. At the 2.7 GHz (the first resonance), the antenna structure operates in the DM mode, and the current on the radiator is asymmetrically distributed along the ground point, as shown in (b) in FIG. 14.

Between the first resonance and the second resonance, radiation generated by the antenna structure has characteristics of both the CM mode and the DM mode, and there is a phase difference between radiation generated in the CM mode and radiation generated in the DM mode.

FIG. 15 is a current distribution diagram of a current at different moments in one cycle on the antenna structure at the 2.2 GHz (the first frequency band).

At a moment t=0, the antenna structure operates in the CM mode, and the current on the radiator is symmetrically distributed along the ground point, as shown in (a) in FIG. 15.

At a moment t=T/4 (T is a cycle of the current on the radiator), the antenna structure operates in the DM mode, and the current on the radiator of the antenna structure is asymmetrically distributed along the ground point, as shown in (b) in FIG. 15.

At a moment t=T/2, the antenna structure operates in the CM mode, and the current on the radiator is symmetrically distributed along the ground point, as shown in (c) in FIG. 15.

At a moment t=3T/4 (T is the cycle of the current on the radiator), the antenna structure operates in the DM mode, and the current on the radiator of the antenna structure is asymmetrically distributed along the ground point, as shown in (d) in FIG. 15.

As described above, at the 2.2 GHz, the phase difference between the radiation generated in the CM mode and the radiation generated in the DM mode is 90° (T/4). Therefore, good circularly polarized radiation can be generated at the frequency.

As shown in FIG. 16, at the 2.2 GHz, because radiation generated in the CM mode is pulled by the current on the ground plate, in an axial ratio pattern of circular polarization generated by the antenna structure, reverse radiation is generated in the z-axis, resulting in concavity on the generated axial ratio pattern of circular polarization in the direction.

As shown in FIG. 17, at the 2.2 GHz, a gain pattern is obtained by superimposing a gain pattern generated in the CM mode on a gain pattern generated in the DM mode. Therefore, a main radiation direction of the gain pattern is directed to a z-axis direction.

FIG. 18 is a curve graph of axial ratios of circular polarization corresponding to a case in which φ=0° and θ=50°. φ is an angle between a radiation direction and an x-axis in an xoy plane, and θ is an angle between the radiation direction and a z-axis. For example, an axial ratio of circular polarization ≤10 dB. An axial ratio bandwidth of the antenna structure is 2.05 GHz to 2.54 GHz (a relative axial ratio bandwidth is 21.3%).

FIG. 19 is a diagram of another antenna structure 100 according to an embodiment of this application.

As shown in FIG. 19, based on the antenna structure shown in FIG. 11, the antenna structure may further include a switch 130 and a feed unit 140.

Feed points of the radiator 110 include a first feed point 1131 and a second feed point 1132. The first feed point 1131 is disposed between the ground point 111 and the first position 101, and the second feed point 1132 is disposed between the ground point 111 and the second position 102. The switch 130 includes a common port, a first port, and a second port. The switch 130 is configured to switch a status of electrical connection between the common port and the first port or the second port. The common port is electrically connected to the feed unit 140. The first port is electrically connected to the radiator 110 at the first feed point 1131, and the second port is electrically connected to the radiator 110 at the second feed point 1132.

It should be understood that right-hand circular polarization differs from left-hand circular polarization in that a vector of strength of an electric field generated by radiation of the antenna structure periodically draws, by using a vector end point, different rotation directions of a trajectory in space over time. Therefore, in the antenna structure, a position of a feed point may be changed, to change the first phase in the first polarization direction and the second phase in the second polarization direction that are generated by the antenna structure 100 in the first frequency band. For example, when the first phase is ahead of the second phase (the first phase is greater than the second phase), polarization of the antenna structure 100 is right-hand circular polarization. When the first phase lags behind the second phase (the first phase is less than the second phase), polarization of the antenna structure 100 is left-hand circular polarization.

In the antenna structure shown in FIG. 19, a position at which an electrical signal is fed by the radiator 110 may be changed by changing the status of electrical connection between the common port and the first port or the second port. This may change the first phase in the first polarization direction and the second phase in the second polarization direction that are generated by the antenna structure 100 in the first frequency band, change a rotation direction of circular polarization, and switch between left-hand circular polarization and right-hand circular polarization.

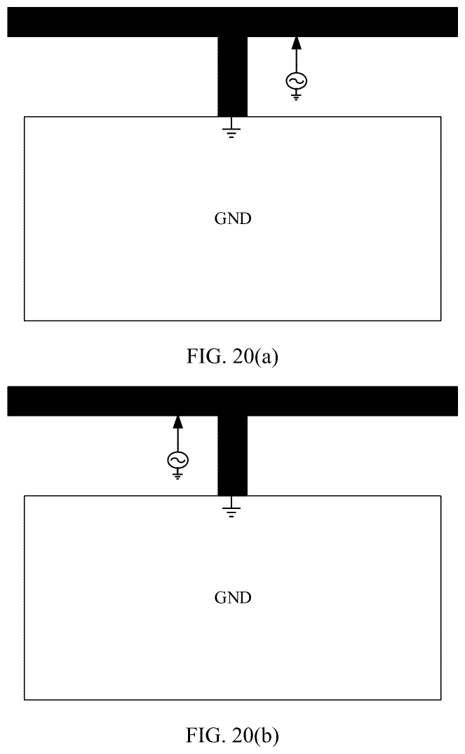

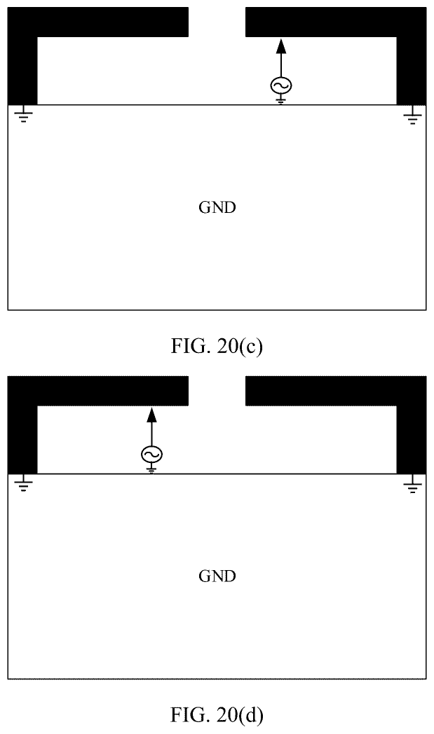

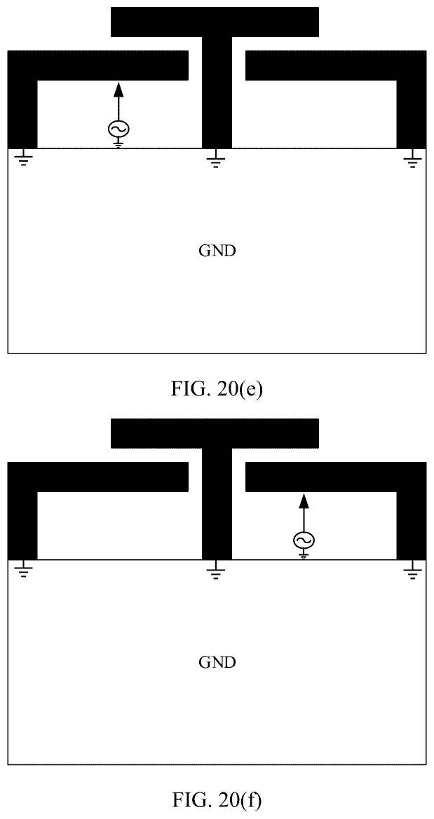

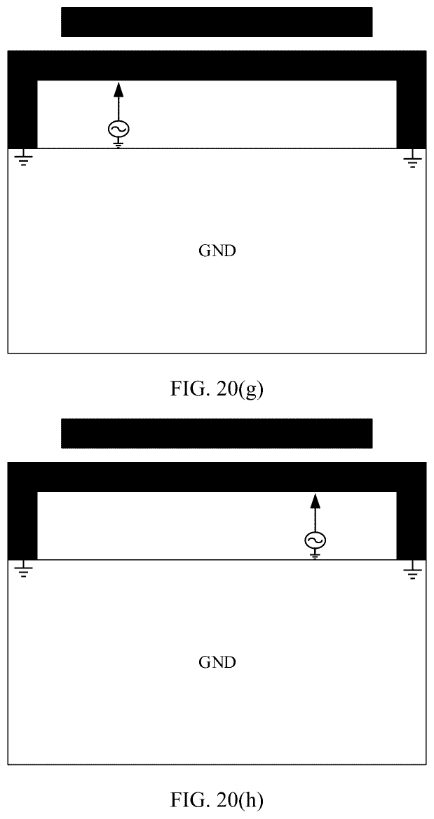

It should be understood that in the plurality of antenna structure combinations with orthogonal polarizations shown in FIG. 10(a) to FIG. 10(d), the position of the feed point may be changed, to switch between left-hand circular polarization and right-hand circular polarization, as shown in FIG. 20(a) to FIG. 20(h).

For example, if the feed points are respectively disposed on two sides of the ground point, switching may be performed between left-hand circular polarization and right-hand circular polarization ((left-hand circular polarization) and (right-hand circular polarization) shown in FIG. 20(a) and FIG. 20(b)) of the combination of the CM mode of the linear antenna and the DM mode of the linear antenna.

Similarly, the position of the feed point may be adjusted, to perform switching between left-hand circular polarization and right-hand circular polarization ((left-hand circular polarization) and (right-hand circular polarization) shown in FIG. 20(c) and FIG. 20(d)) of the combination of the CM mode of the slot antenna and the DM mode of the slot antenna, between left-hand circular polarization and right-hand circular polarization ((left-hand circular polarization) and (right-hand circular polarization) shown in FIG. 20(e) and FIG. 20(f)) of the combination of the CM mode of the linear antenna and the CM mode of the slot antenna, and between left-hand circular polarization and right-hand circular polarization ((left-hand circular polarization) and (right-hand circular polarization) shown in FIG. 20(g) and FIG. 20(h)) of the combination of the DM mode of the linear antenna and the DM mode of the slot antenna.

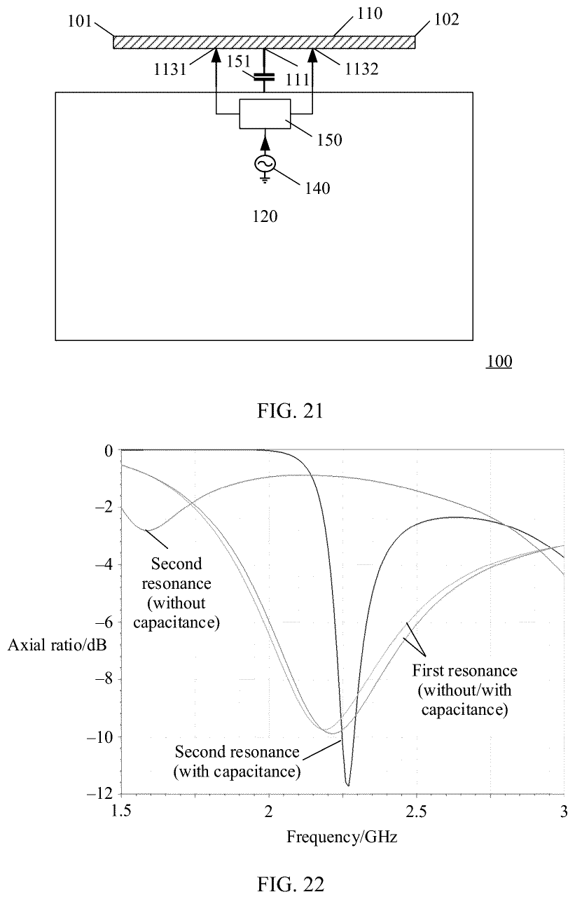

FIG. 21 is a diagram of another antenna structure 100 according to an embodiment of this application.

As shown in FIG. 21, the antenna structure 100 may include the radiator 110 and the ground plate 120. The antenna structure 100 may generate a first resonance and a second resonance.

The radiator 110 includes the ground point 111. The radiator 110 is grounded at the ground point 111 through the ground plate 120. Feed points of the radiator 110 include the first feed point 1131 and the second feed point 1132. The first feed point 1131 is disposed between the ground point 111 and the first position 101, and the second feed point 1132 is disposed between the ground point 111 and the second position 102.

In an embodiment, the antenna structure 100 may further include a feed network 150. The feed network 150 includes an input port, a first output port, and a second output port. The input port is electrically connected to the feed unit 140. The first output port is electrically connected to the radiator 110 at the first feed point 1131, and the second output port is electrically connected to the radiator 110 at the second feed point 1132. The feed network 150 may be configured to adjust a phase of an electrical signal fed at the first feed point 1131 and a phase of an electrical signal fed at the second feed point 1132.

In an embodiment, the feed network 150 may be in a form of distributed feeding. A length and a width of a transmission line between the input port and the first output port, and a length and a width of a transmission line between the input port and the second output port may be adjusted, to adjust a phase of an electrical signal output by the first output port and a phase of an electrical signal output by the second output port. In this way, electrical signals fed at the first feed point 1131 and the second feed point 1132 have equal amplitudes and a fixed phase difference, to generate circular polarization.

In an embodiment, a frequency of the first resonance may be the same as a frequency of the second resonance. For example, a capacitor 151 may be disposed between the ground point 111 and the ground plate 120 (one end of the capacitor 151 is electrically connected to the radiator 110 at the ground point 111, and the other end is grounded), so that the frequency of the second resonance may be shifted to a high frequency, and the frequency of the first resonance basically remains unchanged, as shown in FIG. 22. In an embodiment, a capacitance value of the capacitor 151 may be less than or equal to 10 pF. For example, the capacitance value of the capacitor 151 is 4 pF. It should be understood that in an embodiment of the application, only an example in which the capacitance value of the capacitor 151 is 4 pF is used for description. In an actual design or in actual application, the capacitance value may be adjusted. This is not limited in this application.

In an embodiment, when the frequency of the first resonance is the same as the frequency of the second resonance, a difference between the phase of the electrical signal fed at the first feed point 1131 and the phase of the electrical signal fed at the second feed point 1132 is 90°+25°. In this way, the antenna structure 100 is circularly polarized at the frequency of the first resonance or at the frequency of the second resonance.

In an embodiment, when the frequency of the first resonance is different from the frequency of the second resonance, the phase of the electrical signal fed at the first feed point 1131 and the phase of the electrical signal fed at the second feed point 1132 may be adjusted. In this way, in the first frequency band between the frequency of the first resonance and the frequency of the second resonance, there is a phase difference between radiation generated in the CM mode and radiation generated in the DM mode. For example, the phase difference is greater than 25° and less than 155°.

It should be understood that compared with the antenna structure shown in FIG. 11, the antenna structure 100 shown in FIG. 21 has more feed points, and the electrical signals with the fixed phase difference are fed at two feed points. Switching between right-hand circular polarization and left-hand circular polarization of the antenna structure may be controlled based on the phases of the electrical signals fed at the first feed point 1131 and the second feed point 1132.

For example, when the phase of the electrical signal fed at the first feed point 1131 is ahead of the phase of the electrical signal fed at the second feed point 1132, polarization of the antenna structure 100 is right-hand circular polarization. When the phase of the electrical signal fed at the first feed point 1131 lags behind the phase of the electrical signal fed at the second feed point 1132, polarization of the antenna structure 100 is left-hand circular polarization.

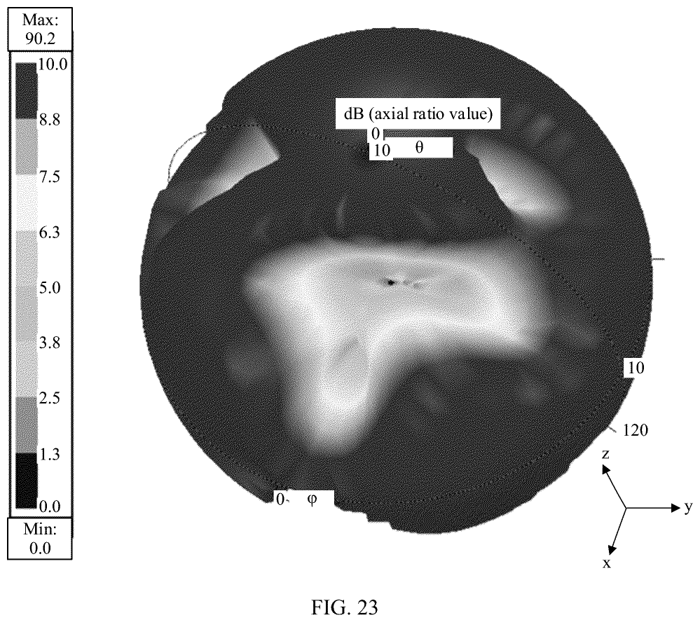

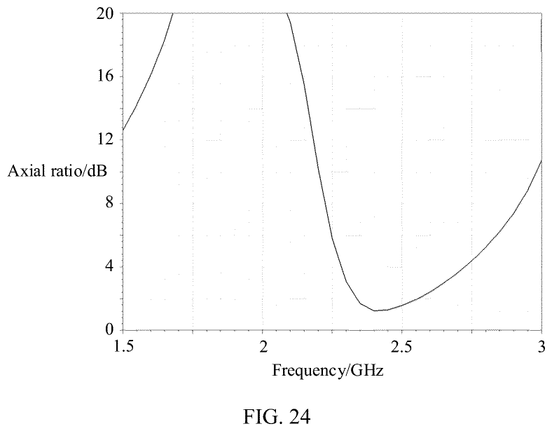

FIG. 23 and FIG. 24 are diagrams of simulation results of the antenna structure shown in FIG. 21. FIG. 23 is a gain pattern of the antenna structure shown in FIG. 21. FIG. 24 is a curve graph of axial ratios of circular polarization of the antenna structure shown in FIG. 21.

As shown in FIG. 23, when the difference between the phase of the electrical signal fed at the first feed point 1131 and the phase of the electrical signal fed at the second feed point 1132 is 90°+25°, because radiation generated in the CM mode is pulled by the current on the ground plate, in an axial ratio pattern of circular polarization generated by the antenna structure, reverse radiation is generated in the z-axis. In this way, the generated axial ratio pattern of circular polarization is concave in the direction.

FIG. 24 is a curve graph of axial ratios of circular polarization corresponding to a case in which φ=0° and θ=50°. φ is an angle between a radiation direction and an x-axis in an xoy plane, and θ is an angle between the radiation direction and a z-axis. For example, an axial ratio of circular polarization ≤10 dB. An axial ratio bandwidth of the antenna structure is 2.2 GHz to 2.98 GHz (a relative axial ratio bandwidth is 30.1%). Because the antenna structure shown in FIG. 21 uses a double-feed manner (feeding is simultaneously performed at two feed points), an axial ratio bandwidth of circular polarization of the antenna structure shown in FIG. 21 is greatly improved compared with that of the antenna structure shown in FIG. 11.

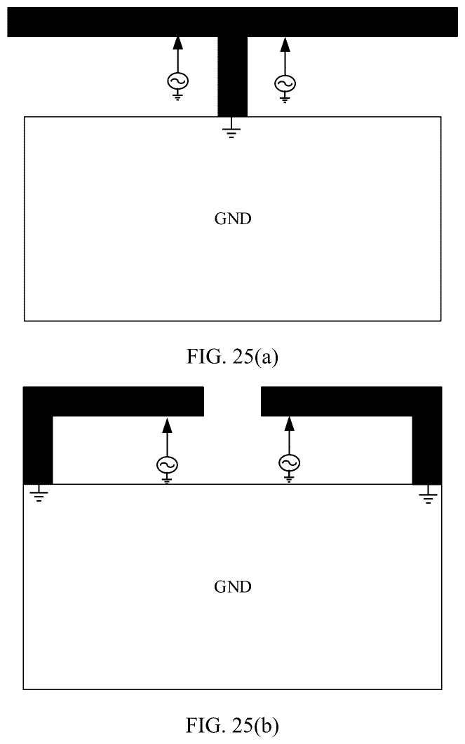

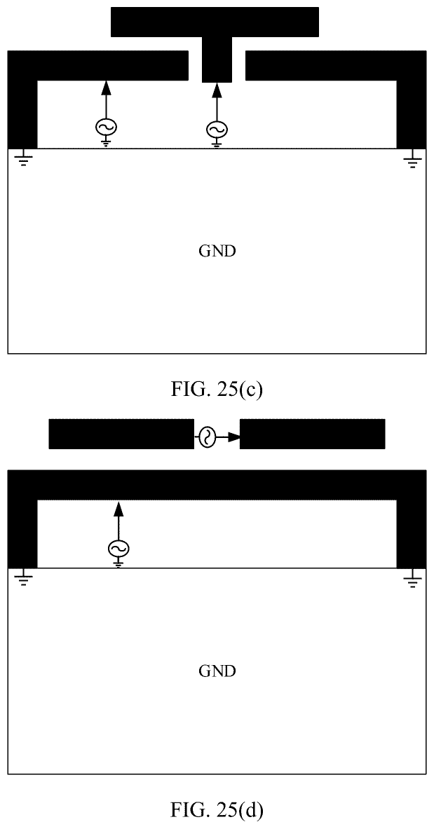

It should be understood that in the plurality of antenna structure combinations with orthogonal polarizations shown in FIG. 10(a) to FIG. 10(d), feeding may alternatively be performed by providing two feed points, to improve radiation performance of the antenna structure, as shown in FIG. 25(a) to FIG. 25(d).

The combination of the CM mode of the linear antenna and the DM mode of the linear antenna is shown in FIG. 25(a). The combination of the CM mode of the slot antenna and the DM mode of the slot antenna is shown in FIG. 25(b). The combination of the CM mode of the linear antenna and the CM mode of the slot antenna is shown in FIG. 25(c). The combination of the DM mode of the linear antenna and the DM mode of the slot antenna is shown in FIG. 25(d).

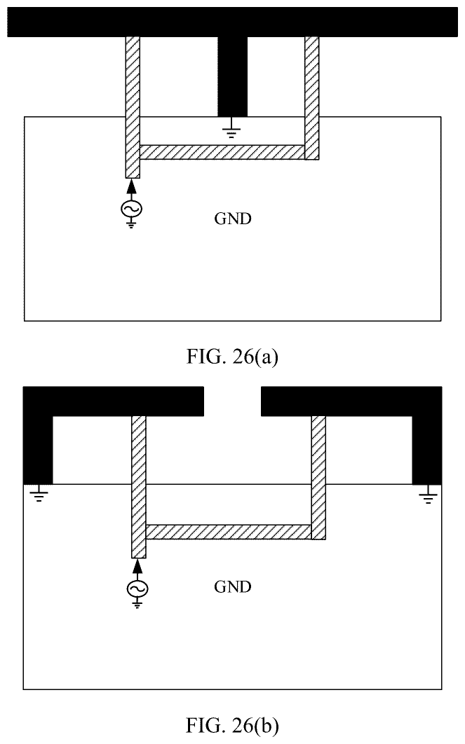

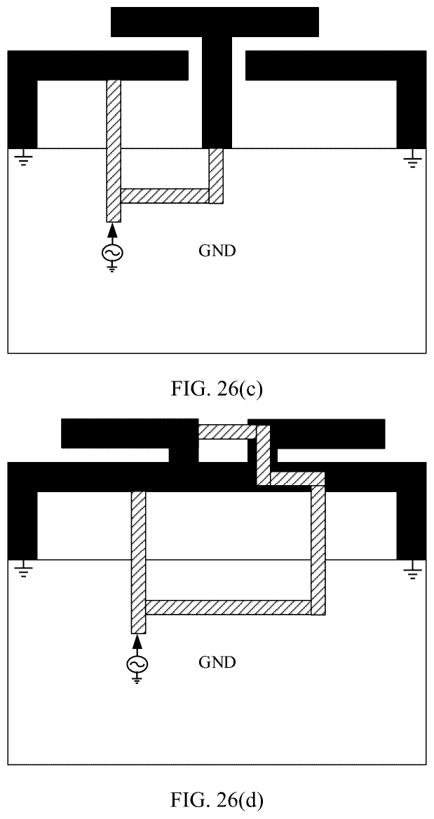

In addition, in the antenna structure combination shown in FIG. 25(a) to FIG. 25(d), a distributed feed network may be used, so that electrical signals fed at two feed points have equal amplitudes and the fixed phase difference, to implement circular polarization, as shown in FIG. 26(a) to FIG. 26(d).

For example, phases of the electrical signals fed at the two feed points may be implemented based on a difference between lengths of transmission lines connected to the two feed points. For example, when the difference between the lengths of the transmission lines connected to the two feed points is half of a wavelength (a wavelength corresponding to a frequency of an electrical signal), the phase difference between the electrical signals fed at the two feed points is 180°. Alternatively, when the difference between the lengths of the transmission lines connected to the two feed points is a quarter of a wavelength (a wavelength corresponding to a frequency of an electrical signal), the phase difference between the electrical signals fed at the two feed points is 90°.

In an embodiment, the phase difference between the electrical signals fed at the two feed points is greater than 30° and less than 150°. For example, in the structure shown in FIG. 26(a) to FIG. 26(d), the difference between the lengths of the transmission lines connected to the two feed points may be greater than one-twelfth of the wavelength and less than five-twelfths of the wavelength.

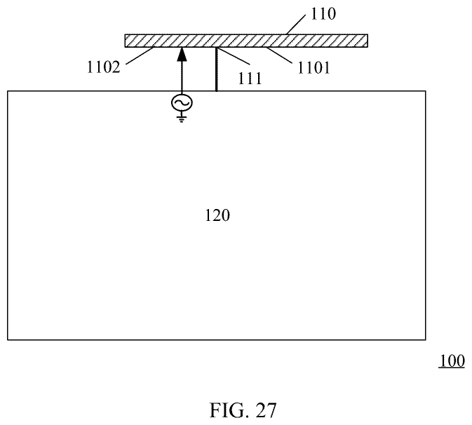

FIG. 27 is a diagram of another antenna structure 100 according to an embodiment of this application.

As shown in FIG. 27, the antenna structure 100 may include the radiator 110 and the ground plate 120.

The radiator 110 includes the ground point 111. The radiator 110 is divided into a first radiator part 1101 and a second radiator part 1102 by the ground point 111, and a length of the first radiator part 1101 is different from a length of the second radiator part 1102.

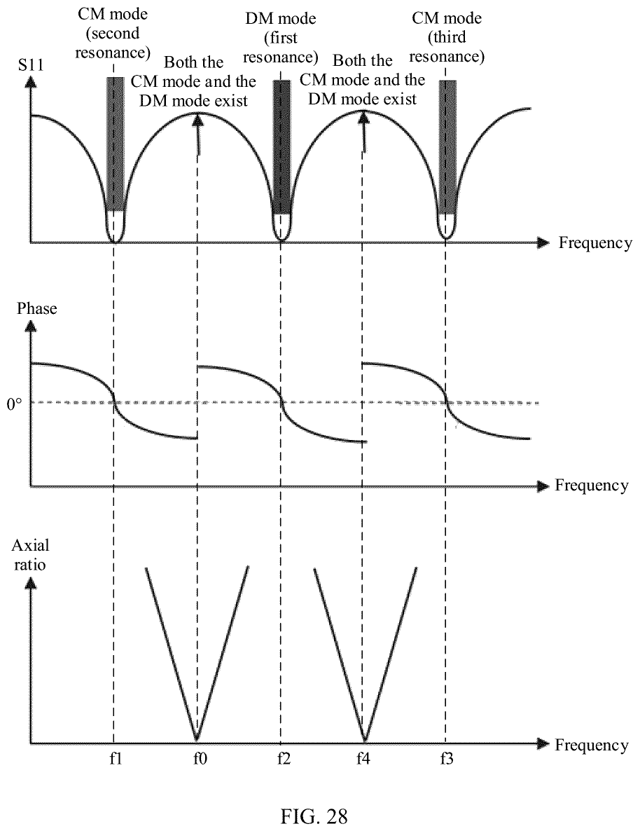

It should be understood that in the antenna structure shown in FIG. 11, the ground point is disposed in a central region of the radiator, to form a symmetrical T-shaped structure. In the antenna structure 100 shown in FIG. 27, the ground point 111 is disposed off the central region of the radiator 110, so that an electrical length of the first radiator part 1101 is different from an electrical length of the second radiator part 1102 (for example, a difference between the electrical length of the first radiator part 1101 and the electrical length of the second radiator part 1102 is greater than a quarter of a wavelength, where the wavelength may be, for example, a wavelength corresponding to a low frequency in generated resonance), to form an asymmetrical T-shaped structure. Because the electrical length of the first radiator part 1101 is different from the electrical length of the second radiator part 1102, when an electrical signal is fed into the radiator 110, in the antenna structure 100 shown in FIG. 27, the first resonance may be generated when the entire radiator 110 operates in the DM mode, the second resonance may be generated when the first radiator part 1101 operates in the CM mode, and third resonance may be generated when the second radiator part 1102 operates in the CM mode, as shown in FIG. 28.

As shown in (a) in FIG. 28, the antenna structure may generate the first resonance, the second resonance, and the third resonance. Frequencies of the second resonance, the first resonance, and the third resonance are sequentially in an ascending order. It can be learned from the foregoing embodiment that when a ratio of the frequency of the second resonance to the frequency of the first resonance is greater than 1 and less than or equal to 1.5, the first frequency band exists between the frequency of the second resonance and the frequency of the first resonance. In the frequency band, both the CM mode and the DM mode exist, so that the antenna structure may generate circular polarization.

In an embodiment, when a ratio of the frequency of the second resonance to the frequency of the first resonance is greater than 1.2 or less than or equal to 1.35, the first frequency band exists between the frequency of the second resonance and the frequency of the first resonance, so that the antenna structure 100 has better circular polarization in the first frequency band.

Therefore, when a ratio of the frequency of the third resonance to the frequency of the first resonance is greater than 1 and less than or equal to 1.5, a second frequency band exists between the frequency of the third resonance and the frequency of the first resonance. In the frequency band, both the CM mode and the DM mode exist. At a frequency f4 in the second frequency band, a phase of a radiation component corresponding to the CM mode is −φ1, and a phase of a radiation component corresponding to the DM mode is +φ2, as shown in (b) in FIG. 28.

When a frequency difference between the frequency of the resonance generated in the CM mode and the frequency of the resonance generated in the DM mode is adjusted to a proper range, φ1+φ2≈90° may be met. In other words, a phase difference between the CM mode and the DM mode is about 90°. In addition, at the frequency f4, an amplitude of the radiation component corresponding to the CM mode is approximately the same as an amplitude of the radiation component corresponding to the DM mode. In the second frequency band, the antenna structure 100 may implement circular polarization (the axial ratio of circular polarization is less than or equal to 10 dB) in the CM mode and the DM mode with orthogonal polarizations.

In an embodiment, when the ratio of the frequency of the third resonance to the frequency of the first resonance is greater than 1.2 and less than or equal to 1.35, the second frequency band exists between the frequency of the third resonance and the frequency of the first resonance, so that the antenna structure 100 has better circular polarization in the second frequency band.

The antenna structure 100 shown in FIG. 27 may generate circular polarization in both the first frequency band between the first resonance and the second resonance and the second frequency band between the first resonance and the third resonance, so that the antenna structure includes two operating frequency bands for circular polarization. In this way, a bandwidth of the antenna structure is expanded. Therefore, when the ground point 111 is disposed in the central region (the antenna structure shown in FIG. 11), one frequency band between resonance generated in the CM mode and resonance generated in the DM mode of the antenna may be used, so that a polarization manner of the antenna structure in the frequency band is circular polarization. When the ground point 111 is off the central region (the antenna structure shown in FIG. 27), two frequency bands between two types of resonance generated in the CM mode and the resonance generated in the DM mode of the antenna may be used, so that polarization manners of the antenna structure in the two frequency bands are both circular polarization.

In an embodiment, the antenna structure 100 may use a frame of an electronic device as a radiator to form a frame antenna. For example, the frame of the electronic device has a first position and a second position, gaps are respectively disposed on the frame at the first position and the second position, and a first frame between the first position and the second position is used as the radiator 110.

For example, a distance between the radiator 110 to the ground plate 120 is less than a first threshold, where the first threshold may be, for example, 1 mm, 1.5 mm, or 2 mm. The antenna structure 100 can still implement circular polarization in a small-clearance environment.

In an embodiment, the antenna structure 100 shown in FIG. 27 may alternatively be used in the foregoing solution of switching between left-hand circular polarization and right-hand circular polarization, for example, changing the position of the feed point, to switch between left-hand circular polarization and right-hand circular polarization. Alternatively, electrical signals of different phases are fed at two feed points, to switch between left-hand circular polarization and right-hand circular polarization.

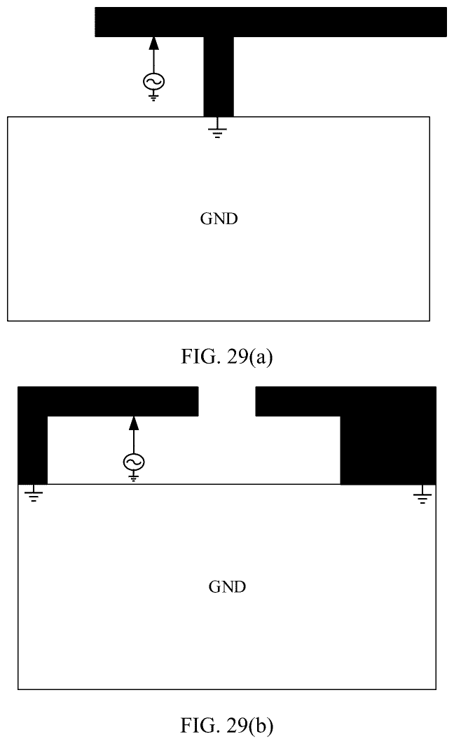

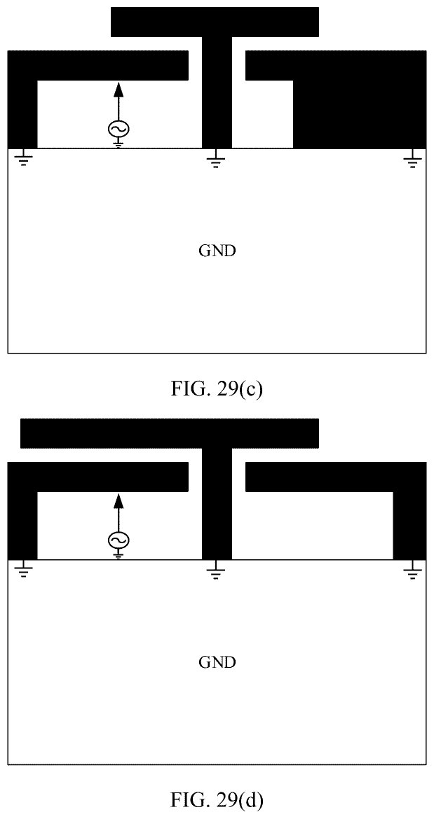

It should be understood that in the plurality of antenna structure combinations with orthogonal polarizations shown in FIG. 10(a) to FIG. 10(d), lengths of radiator parts of the radiator on two sides of the ground point or lengths of radiator parts of the radiator on two sides of the slot may be changed, so that the antenna structure has two operating frequency bands for circular polarization, as shown in FIG. 29(a) to FIG. 29(d).

In FIG. 27, only the combination of the CM mode of the linear antenna and the DM mode of the linear antenna (as shown in FIG. 29(a)) is used as an example for description. The combination of the CM mode of the slot antenna and the DM mode of the slot antenna (as shown in FIG. 29(b)), the combination of the CM mode of the linear antenna and the CM mode of the slot antenna (as shown in FIG. 29(c)), and the combination of the DM mode of the linear antenna and the DM mode of the slot antenna (as shown in FIG. 29(d)) may also be used in the technical solution.

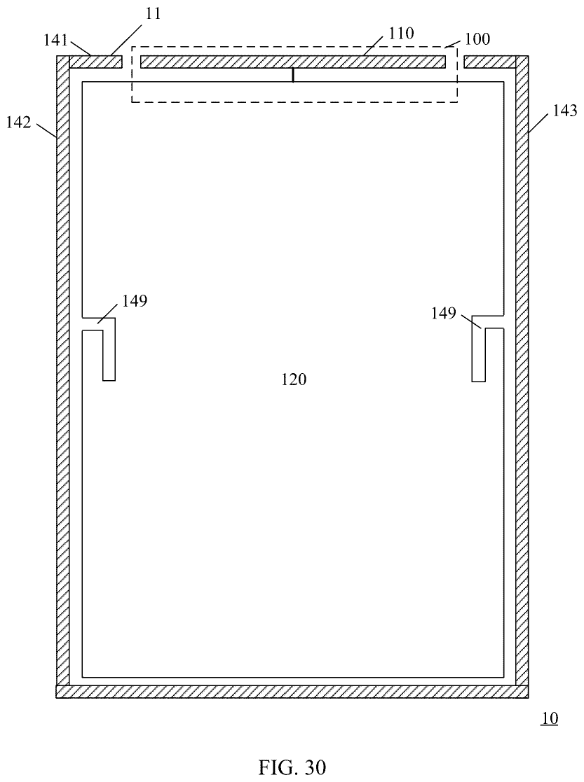

FIG. 30 is a diagram of an electronic device 10 according to an embodiment of this application.

As shown in FIG. 30, the electronic device 10 may include the antenna structure 100, and the antenna structure 100 may be the antenna structure according to any one of the foregoing embodiments.

As shown in FIG. 30, the frame 11 of the electronic device 10 may include a first edge 141 and a second edge 142 that intersect (for example, are connected) at an angle. The radiator 110 of the antenna structure 100 includes a first frame of the frame 11, and at least a part of the first frame is located on the first edge 141. A slot 149 is disposed on the ground plate 120 at a position corresponding to the second edge 142, and a distance between the slot 149 and the first frame is less than half of a length of the second edge 142. The distance between the slot 149 and the first frame may be understood as a minimum value of a straight-line distance between a conductor around the slot 149 and a point on the first frame. For brevity of description, a uniform gap is displayed between the ground plate 120 and the frame 11 shown in FIG. 30. In an actual product, a width of the slot between the ground plate 120 and the frame 11 in different regions may be adjusted based on a layout of the electronic device. A plurality of gaps may be further disposed on the frame 11. A frame between adjacent gaps is used as a radiator of another antenna, to implement a communication function of the electronic device in different frequency bands. In addition, a plurality of ground cables, ground spring plates, or ground ribs may be disposed between the frame 11 and the ground plate 120, to implement grounding of each antenna radiator. This is not limited in this application.

It should be understood that in an application process of a circularly polarized antenna, because the electronic device needs to communicate with a satellite, the antenna needs to generate a directional beam to better establish a connection to the satellite, as shown in FIG. 6. Because the ground plate in the electronic device is large and the current is pulled by the ground plate, a pattern generated by the antenna structure is often uncontrollable. A current distribution on the ground plate 120 may be adjusted by providing the slot on the ground plate, to control the pattern generated by the antenna structure.

In addition, because the slot 149 cuts off a part of the current distributed over the ground plate 120, the slot 149 may also generate radiation. A generated pattern may be superimposed on the pattern generated by the antenna structure 100. This can improve radiation performance of the antenna structure 100, for example, correcting an axial ratio pattern of circular polarization and a gain pattern.

In an embodiment, a distance between the slot 149 and the first frame is less than half of the length of the second edge 142, and is greater than a quarter of the length of the second edge 142. The distance between the slot 149 and the first frame may be understood as the minimum distance between the slot 149 and the first frame.

In an embodiment, a length of the slot 149 may be a quarter of a first wavelength, and the first wavelength is a wavelength corresponding to an operating frequency band of the antenna structure 100. The length of the slot 149 may be understood as an extension length of the slot 149, including a sum of extension lengths of the slot 149 in all bending directions.

In an embodiment, a plurality of slots 149 may be disposed on the ground plate 120. For example, the frame 11 may include the first edge 141 and a third side 143 that intersect (for example, are connected) at an angle. The slot 149 is disposed on the ground plate 120 at a position corresponding to the third side 143.

In an embodiment, slots 149 are disposed on the ground plate 120 on two sides of the antenna structure 100, so that the overall structure is symmetrical, and performance of the antenna structure 100 can be further improved. Alternatively, in an embodiment, the electronic device has a compact layout inside, and only one slot 149 can be disposed on the ground plate 120. This is not limited in this application.

In an embodiment, the slot 149 may be of a straight line shape, an L shape, a bent-line shape, or the like. This is not limited in this application.

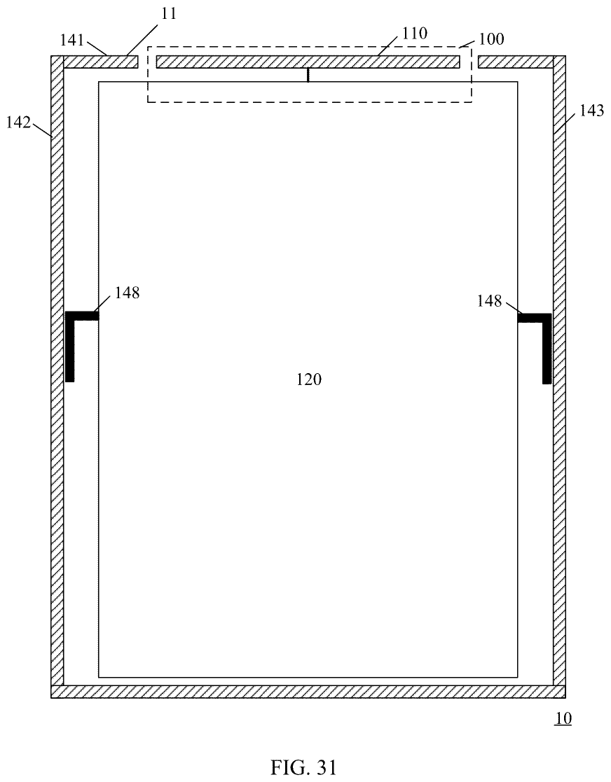

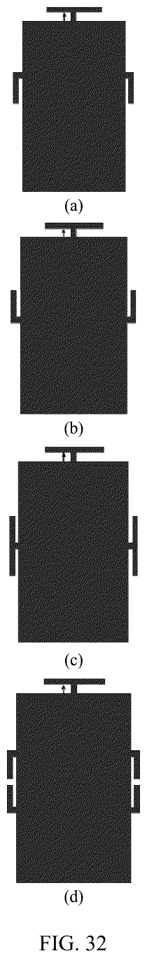

FIG. 31 is a diagram of another electronic device 10 according to an embodiment of this application.

As shown in FIG. 31, the electronic device 10 may include the antenna structure 100, and the antenna structure 100 may be the antenna structure according to any one of the foregoing embodiments.

It should be understood that compared with the electronic device shown in FIG. 30, in the electronic device shown in FIG. 31, a slot disposed on the ground plate may be replaced with a resonant stub. For example, as shown in FIG. 31, a resonant stub 148 may be disposed between the second edge 142 and the ground pate 120, and one end of the resonant stub 142 is electrically connected to the ground plate 120. A distance between the resonant stub 148 and the first frame that is used as the radiator 110 of the antenna structure 100 is less than half of the length of the second edge 142.

It should be understood that the distance between the resonant stub 148 and the first frame that is used as the radiator 110 of the antenna structure 100 may be understood as a minimum value of a straight-line distance between the resonant stub 148 and a point on the first frame.

In an embodiment, a distance between the resonant stub 148 and the first frame is less than half of the length of the second edge 142, and is greater than a quarter of the length of the second edge 142. In an embodiment, a plurality of resonant stubs 148 may be disposed on the ground plate 120. For example, the frame 11 may include the first edge 141 and the third side 143 that intersect (for example, are connected) at an angle. The resonant stub 148 may be disposed between the third side 143 and the ground pate 120, and one end of the resonant stub 148 is electrically connected to the ground plate 120.

In an embodiment, resonance stubs 148 are disposed on two sides of the antenna structure 100, so that the overall structure is symmetrical, and performance of the antenna structure 100 can be further improved. Alternatively, in an embodiment, the electronic device has a compact layout inside, and only one resonance stub 148 can be disposed. This is not limited in this application.

In an embodiment, the resonant stub 148 may be of an L shape with an opening facing away from the antenna structure 100, an L shape with an opening facing the antenna structure 100, or a T shape or a double-L shape with circular polarization, as shown in FIG. 32. Alternatively, the resonant stub 148 may be of another shape, for example, a straight line (I shape). This is not limited in this application.

It should be understood that an implementation of the resonant stub 148 is not limited in this application. For example, in an embodiment, the resonant stub 148 may be implemented using a metal sheet disposed on a surface (or a side) of a PCB, for example, an L-shaped stub (one end of the metal sheet is electrically connected to the ground plate), or a T-shaped stub (a central region of the metal sheet is connected to the ground plate).

In an embodiment, the resonant stub 148 may alternatively be disposed on a rear cover of the electronic device using a floating metal (FLM) technology, or disposed on the PCB using a support or the like. In this case, the resonant stub 148 may not be disposed between the second edge 142 and the ground plate 120 as shown in FIG. 31. Instead, at least a part of the resonant stub 148 is disposed on the ground plate 120. For example, a projection of the resonant stub 148 along a first direction on a plane on which the ground plate 120 is located is at least partially located on the plane on which the ground plate 120 is located. This helps further reduce spacing between the ground plate 120 and the second edge 142. For example, the spacing may be less than 2 mm, or even less than 1.5 mm or 1 mm. The spacing between the ground plate 120 and the second edge 142 may be understood as minimum spacing between an edge that is of the ground plate 120 and that corresponds to the region in which the resonant stub 148 is disposed and the second edge 142.

Alternatively, in an embodiment, the resonant stub 148 may be implemented using the frame 11, for example, an L-shaped stub (a slot and a ground point are disposed on the second edge 142 of the frame 11, and a frame between the ground point and the slot is used as the resonant stub 148, as shown in (a) and (b) in FIG. 32), or a T-shaped stub (two slots are disposed on the second edge 142 of the frame 11, a frame between the two slots is used as the resonant stub 148, and a ground point is disposed between the two slots, as shown in (c) in FIG. 32).

It should be understood that when the resonant stub 148 is implemented using the frame 11, a part of the frame 11 may be used as the resonant stub 148. In addition, for a more compact layout in the electronic device, the part of the frame 11 may be reused as a radiator of another antenna element. A switch or the like may be used to perform switching on the frame 11, to use the frame 11 as the radiator of another antenna or as the resonant stub of the antenna structure 100. This is not limited in this application.

Alternatively, in an embodiment, the resonant stub 148 may be implemented by carving out a slot on the ground plate 120. Alternatively, the resonant stub 148 may be implemented by disposing a rib for the slot between the ground plate 120 and the frame 11.

Alternatively, in an embodiment, the resonant stub 148 may be implemented using a metal mechanical piece, for example, a middle frame, and may be adjusted based on a layout manner in the electronic device.

In an embodiment, when the resonant stub 148 is the L-shaped stub, an electrical length of the resonant stub 148 (for example, when the resonant stub 148 is implemented using the frame, a length of the resonant stub 148 may be understood as a length of the frame between the gap and the ground point) may be a quarter of a first wavelength, and the first wavelength is a wavelength corresponding to an operating frequency band of the antenna structure 100. Alternatively, when the resonant stub 148 is the T-shaped stub, an electrical length of the resonant stub 148 (for example, when the resonant stub 148 is implemented using the frame, a length of the resonant stub 148 may be understood as a length of the frame between the two gaps) may be half of a first wavelength, and the ground point may be disposed in a central region of the resonant stub.

It should be understood that an electronic component may be disposed between the resonant stub 148 and the ground plate 120, to adjust the electrical length of the resonant stub 148. For example, an inductor or a capacitor may be provided, so that the electrical length of the resonant stub 148 may be adjusted based on a fixed physical length of the resonant stub 148, to meet the required electrical length. In an embodiment, the physical length of the resonant stub 148 may be greater than or equal to (the first wavelength×70%) and less than or equal to (the first wavelength×130%).

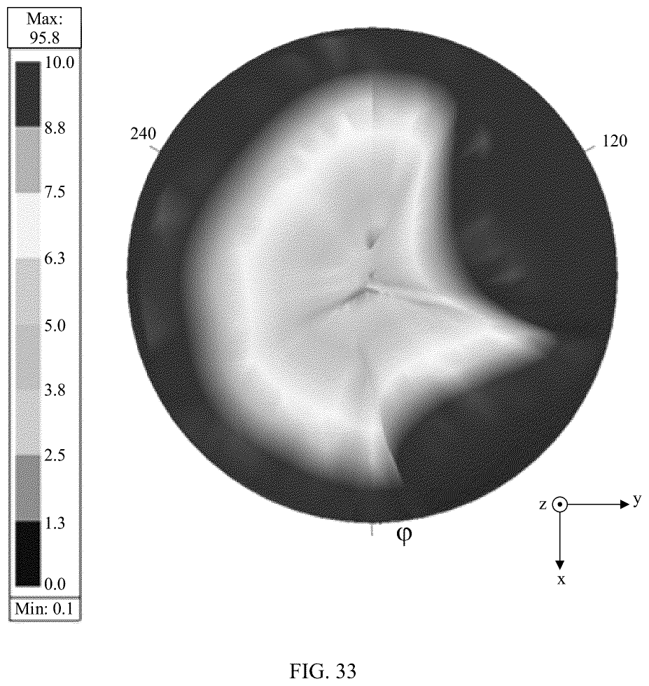

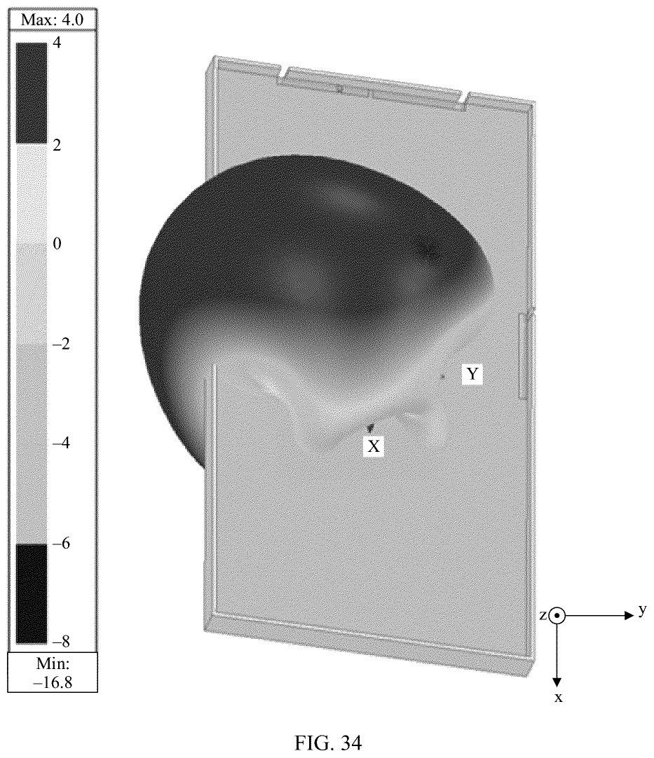

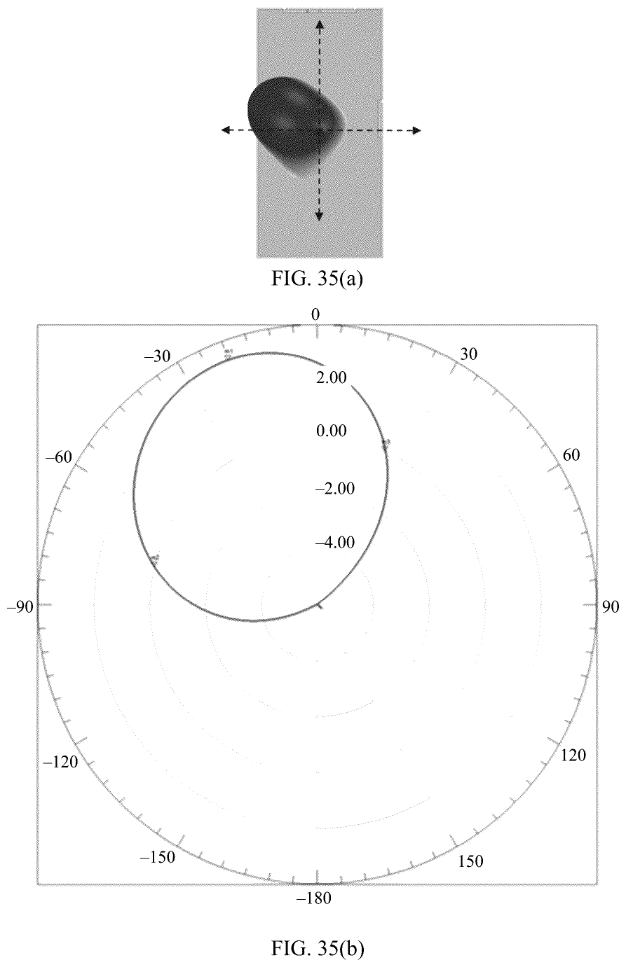

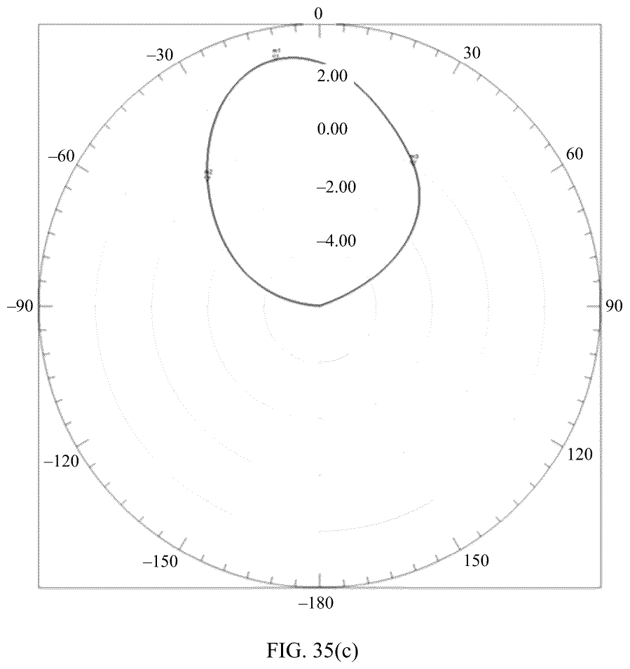

FIG. 33 to FIG. 35(a) to FIG. 35(c) are diagrams of simulation results of the antenna structure shown in (b) in FIG. 32. FIG. 33 is an axial ratio pattern of circular polarization of the antenna structure shown in (b) in FIG. 32. FIG. 34 is a gain pattern of the antenna structure shown in (b) in FIG. 32. FIG. 35(a) to FIG. 35(c) are patterns corresponding to RHCP of the antenna structure shown in (b) in FIG. 32.

Two L-shaped frame resonant structures are disposed on the second edge and the third side of the frame. Therefore, on one hand, the two resonant structures can suppress the current on the ground plate when the antenna structure radiates, and on the other hand, axial ratio patterns of circular polarization and gain patterns of the two resonant structures can be superimposed on an axis ratio pattern of circular polarization and a gain pattern that are generated by the original antenna structure. In this way, the axial ratio pattern of circular polarization and the gain pattern are corrected, and radiation performance of the antenna structure is improved.

As shown in FIG. 33 and FIG. 34, both the axial ratio pattern of circular polarization and the gain pattern that are generated by the antenna structure have strong components facing the z-axis direction, so that a directional beam may be formed, and the electronic device can communicate with the satellite.

FIG. 35(a) is an overall pattern corresponding to RHCP of the antenna structure, where a maximum gain of the overall pattern is 3.7 dB. FIG. 35(b) is a pattern corresponding to RHCP of the antenna structure when φ=−77° and θ=24°, where a maximum gain of the pattern is 3.3 dB. FIG. 35(c) is a pattern corresponding to RHCP of the antenna structure when φ=−42° and θ=34°, where a maximum gain of the pattern is 2.9 dB.

It should be understood that for a circular polarization pattern generated by an antenna structure in an electronic device, the circular polarization pattern includes a gain pattern and an axial ratio pattern of circular polarization. Advantages and disadvantages of circular polarization generated by the antenna structure need to be represented using the two types of patterns.

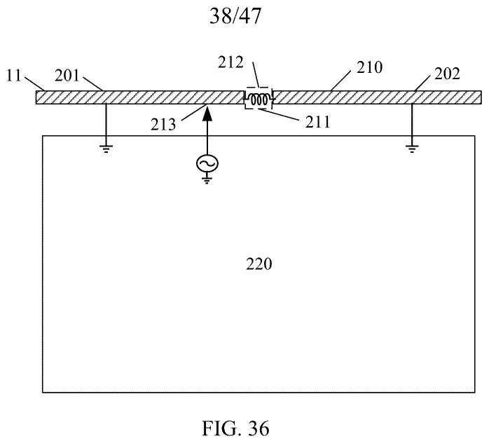

FIG. 36 is a diagram of an antenna structure 200 according to an embodiment of this application.

As shown in FIG. 36, the antenna structure 200 may include a radiator 210 and the ground plate 120.

The radiator 210 has a slot 211. The frame 11 has a first position 201 and a second position 202, and a first frame between the first position 201 and the second position 202 is used as the radiator 210. The radiator 210 is grounded at the first position 201 and the second position 202 through the ground plate 220. The antenna structure 200 generates first resonance and second resonance. A ratio of a frequency of the first resonance to a frequency of the second resonance is greater than 1 and less than or equal to 1.5. An operating frequency band of the antenna structure 200 includes a first frequency band, and a frequency in the first frequency band is between the frequency of the first resonance and the frequency of the second resonance. An axial ratio of circular polarization of the antenna structure 200 in the first frequency band is less than or equal to 10 dB.

In the antenna structure 200 shown in FIG. 36, the antenna structure 200 is a slot antenna with an opening, and the first resonance and the second resonance may be generated in a CM mode and a DM mode. Generally, a frequency of the resonance generated in the DM mode is higher than a frequency of the resonance generated in the CM mode. For brevity of description, in an embodiment, only an example in which the frequency of the resonance generated in the DM mode is higher than the frequency of the resonance generated in the CM mode is used for description. In actual application, the frequency of the resonance generated in the DM mode may be adjusted to be lower than the frequency of the resonance generated in the CM mode.

The antenna structure 200 generates the first resonance in the DM mode, and generates the second resonance in the CM mode. A frequency by which the first resonance is spaced from the second resonance is adjusted, so that the antenna structure 200 may have both the CM mode and the DM mode in the first frequency band with frequencies between the frequency of the first resonance and the frequency of the second resonance. In the first frequency band, the antenna structure 200 may implement circular polarization (the axial ratio of circular polarization is less than or equal to 10 dB) in the CM mode and the DM mode with orthogonal polarizations.

In an embodiment, in the first frequency band, a difference between a first gain generated by the antenna structure 100 and a second gain generated by the antenna structure 200 is less than 10 dB, so that the antenna structure 200 has good circular polarization. The first gain is a gain of a pattern generated by the antenna structure 200 in a first polarization direction. The second gain is a gain of a pattern generated by the antenna structure 200 in a second polarization direction. The first polarization direction is orthogonal to the second polarization direction. The first polarization direction may be a polarization direction corresponding to the CM mode, and the second polarization direction may be a polarization direction corresponding to the DM mode.

In an embodiment, in the first frequency band, a difference between a first phase generated by the antenna structure 200 and a second phase generated by the antenna structure 200 is greater than 25° and less than 155° (90°+65°), so that the antenna structure 200 has good circular polarization. The first phase is a phase of radiation generated by the antenna structure 100 in the first polarization direction. The second phase is a phase of radiation generated by the antenna structure 200 in the second polarization direction. The first polarization direction is orthogonal to the second polarization direction. The first polarization direction may be a polarization direction corresponding to the CM mode, and the second polarization direction may be a polarization direction corresponding to the DM mode.

In an embodiment, the ratio of the frequency of the first resonance to the frequency of the second resonance is greater than or equal to 1.2 and less than or equal to 1.35, so that the antenna structure 200 has better circular polarization.

In an embodiment, the slot 211 may be disposed in a central region 212 of the radiator 210, so that the antenna structure 200 forms a symmetrical slot antenna. The central region 212 may be considered as a region within a distance to a geometric center or a center of an electrical length of the radiator 210. For example, the central region 212 may be a region within 5 mm to the geometric center of the radiator 210, may be a region within three-eighths to five-eighths of a physical length of the radiator 210, or may be a region within three-eighths to five-eighths of the electrical length of the radiator.

In an embodiment, at the first resonance, the antenna structure 200 operates in the DM mode, an electric field between the radiator 210 of the antenna structure 200 and the ground plate 220 is asymmetrically distributed along a virtual axis of the radiator 210 (for example, being distributed in a same direction). At the second resonance, the antenna structure 100 operates in the CM mode, and the electric field between the radiator 210 of the antenna structure 200 and the ground plate 220 is symmetrically distributed along the virtual axis of the radiator 210. The virtual axis of the radiator 210 may be an axis of symmetry of the radiator 210, and the radiator 210 has equal lengths on two sides of the virtual axis.

In an embodiment, because the antenna structure 200 has both the CM mode and the DM mode in the first frequency band, the electric field between the radiator 210 and the ground plate 220 present different distribution states at different moments in a cycle. For example, the electric field between the radiator 210 and the ground plate 220 are symmetrically distributed along the virtual axis at a first moment (a moment corresponding to the CM mode), and the electric field between the radiator 210 and the ground plate 220 are asymmetrically distributed along the virtual axis at a second moment (a moment corresponding to the DM mode).

In an embodiment, an electronic component may be disposed in the slot 211, and two ends of the electronic component are electrically connected to the radiator 210 on two sides of the slot 211 separately. For example, an inductor may be configured to adjust the frequency of the second resonance corresponding to the CM mode, so that the frequency of the first resonance and the frequency of the second resonance meet a requirement.

In an embodiment, the radiator 210 further includes a feed point 213. The feed point 213 is disposed between the slot 211 and the first position 201, and no feed point is disposed between the slot 211 and the second position 202. It should be understood that the antenna structure 200 uses offset central feed (offset feed/side feed). The antenna structure 200 may generate the resonance in both the CM mode and the DM mode. The structure of the antenna structure 200 is simple, and is easy for performing a layout on the inside of the electronic device.

It should be understood that the technical solution in the foregoing embodiment may also be applied to the antenna structure 200 shown in FIG. 36. For example, the slot 211 may be disposed outside the central region 212 and be disposed off the central region 212, so that the antenna structure 200 may generate two CM operating modes. Alternatively, electrical signals may be fed into the antenna structure 200 at two feed points. For brevity of description, details are not described herein again.

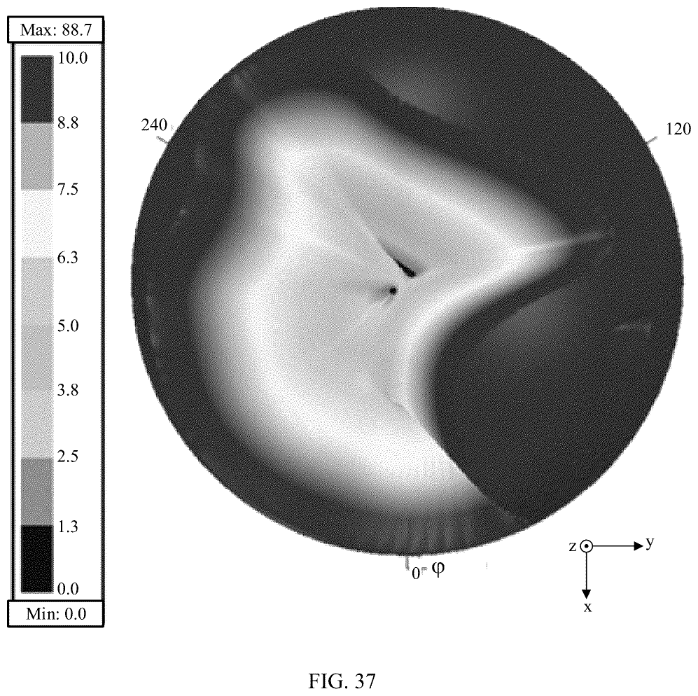

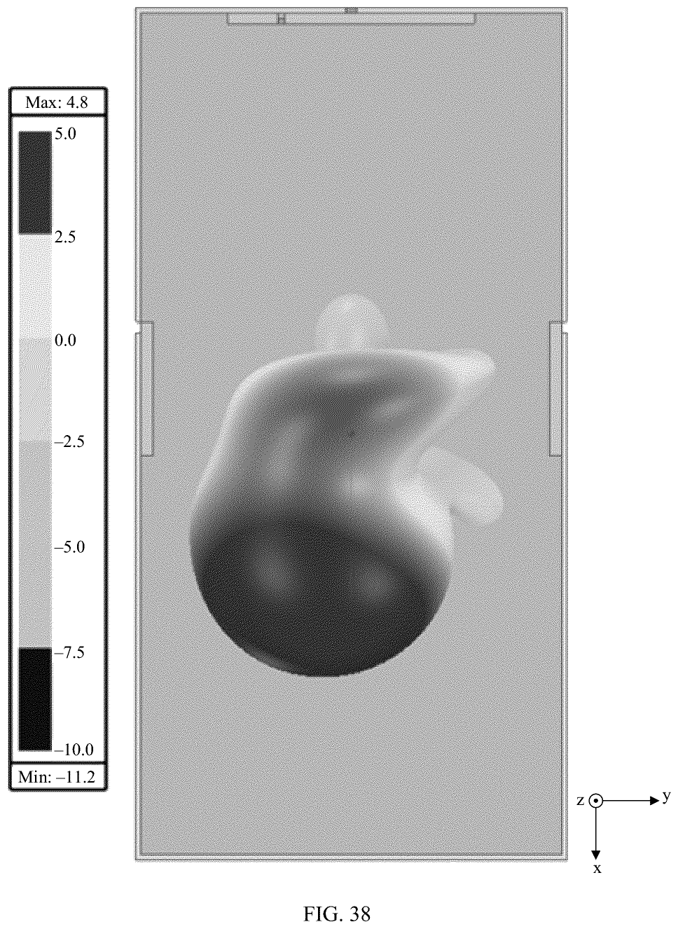

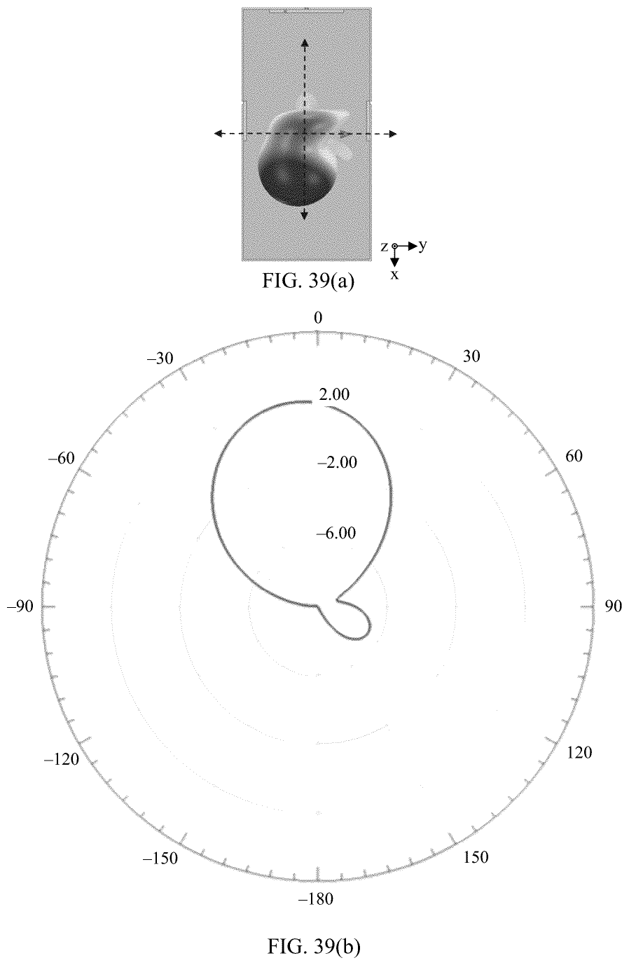

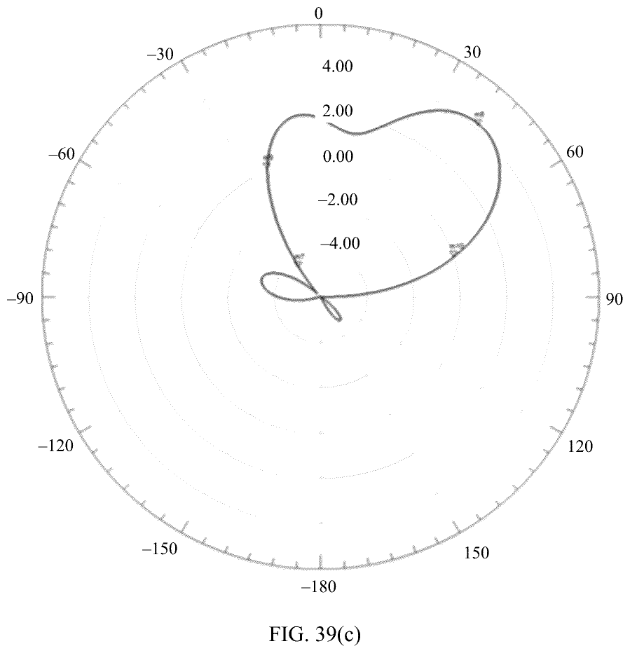

FIG. 37 to FIG. 39(a) to FIG. 39(c) are diagrams of simulation results of the antenna structure shown in FIG. 36. FIG. 37 is an axial ratio pattern of circular polarization of the antenna structure shown in (b) in FIG. 36. FIG. 38 is a gain pattern of the antenna structure shown in FIG. 36. FIG. 39(a) to FIG. 39(c) are patterns corresponding to RHCP of the antenna structure shown in FIG. 36.

Two L-shaped slot resonant structures are disposed on the ground plate at positions corresponding to the second edge and the third side of the frame. Therefore, on one hand, the two resonant structures can suppress the current on the ground plate when the antenna structure radiates, and on the other hand, axial ratio patterns of circular polarization and gain patterns of the two resonant structures can be superimposed on an axis ratio pattern of circular polarization and a gain pattern that are generated by the original antenna structure. In this way, the axial ratio pattern of circular polarization and the gain pattern are corrected, and radiation performance of the antenna structure is improved.

As shown in FIG. 37 and FIG. 38, both the axial ratio pattern of circular polarization and the gain pattern that are generated by the antenna structure have strong components facing the z-axis direction, so that a directional beam may be formed, and the electronic device can communicate with the satellite

FIG. 39(a) is an overall pattern corresponding to RHCP of the antenna structure, where a maximum gain of the overall pattern is 4.4 dB. FIG. 39(b) is a pattern corresponding to RHCP of the antenna structure when φ=−36° and θ=20°, where a maximum gain of the overall pattern is 2 dB. FIG. 39(c) is a pattern corresponding to RHCP of the antenna structure when φ=−22° and θ=73°, where a maximum gain of the overall pattern is 4.2 dB.

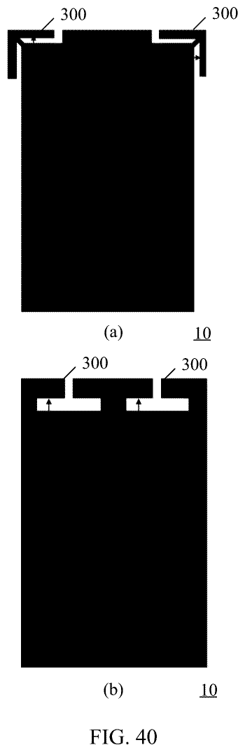

FIG. 40 is a diagram of a structure of an electronic device 10 according to an embodiment of this application.

As shown in FIG. 40, the electronic device 10 may include a plurality of antenna structures 300. The antenna structure 300 may be the antenna structure according to any one of the foregoing embodiments.

As shown in (a) and (b) in FIG. 40, one of two antenna structures 300 may be used as a primary receive (PRX) antenna, and the other antenna structure may be used as a diversity receive (DRX) antenna. The primary receive antenna and the diversity receive antenna are provided, to improve receiving sensitivity of the electronic device. In this way, a user can obtain good communication quality in a poor communication signal environment.

It should be understood that for brevity of description, in an embodiment of this application, only an example in which a radiator of the antenna structure is a frame of the electronic device is used for description. In actual application, the radiator of the antenna structure may be implemented using a floating metal (FLM), or the like. This is not limited in this application.

In addition, when the radiator of the antenna structure is the frame of the electronic device, only a radiator part of the antenna structure is shown in the figure, and frame parts between radiators of a plurality of antenna structures are not shown. For example, in (b) in FIG. 40, a frame on a top region may further include frame parts connected to the radiators of the antenna structure 300.

In an embodiment, feed points of all of the plurality of antenna structures 300 may be disposed on a same side (ground points or slots of the radiators are on a same side), to ensure that circular polarization directions of all of the plurality of antenna structures 300 are consistent, as shown in FIG. 40.

In an embodiment, the plurality of antenna structures 300 may form an antenna array, to improve an overall gain of the antenna structure.

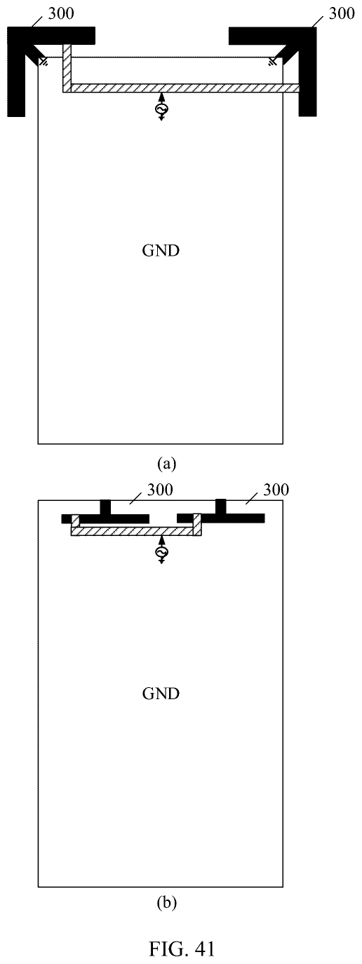

In an embodiment, equal-amplitude in-phase (same amplitude and same phase) feeding may be performed on the plurality of antenna structures 300 through a feed network, to save layout space in the electronic device, as shown in FIG. 41.

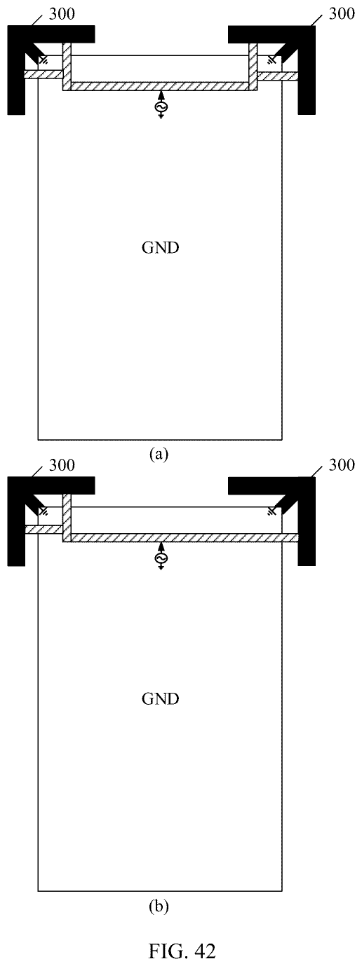

In an embodiment, all of the plurality of antenna structures 300 may use a same feed manner. For example, feeding is performed on the plurality of antenna structures 300 in a double-feed manner, as shown in (a) in FIG. 42. Alternatively, each of the plurality of antenna structures 300 may use a different feed manner. For example, feeding may be performed on one of the antenna structures 300 in a single-feed manner, and feeding may be performed on another antenna structure 300 in the double-feed manner, as shown in (b) in FIG. 42.

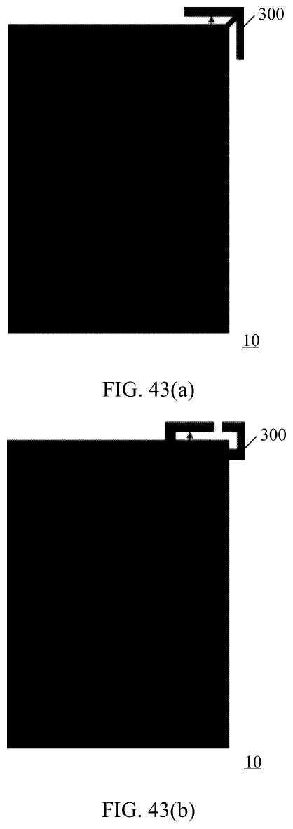

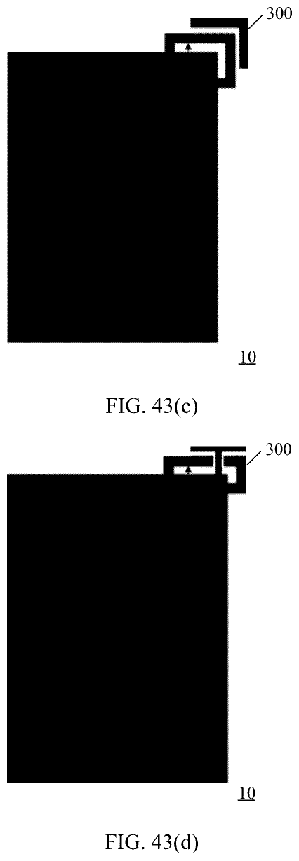

In an embodiment, positions of the antenna structures 300 may be flexibly adjusted based on a layout in the electronic device. This is not limited in this application, as shown in FIG. 43(a) to FIG. 43(d).

It should be understood that in the multi-antenna structure shown in FIG. 40 to FIG. 43(a) to FIG. 43(d), antenna elements in the multi-antenna structure may be the same or different. The antenna elements may be the antenna structure according to any one of the foregoing embodiments. This is not limited in this application.

One of ordinary skilled in the art may use different methods to implement the described functions for each particular application, but it should not be considered that the implementation goes beyond the scope of this application.

One of ordinary skilled in the art may clearly learn that, for the purpose of convenient and brief description, for a working process of the system, apparatus, and unit, refer to a corresponding process in the method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed In addition, the displayed or discussed mutual couplings or direct couplings or communication connections may be implemented by using some interfaces. The indirect couplings or communication connections between the apparatuses or units may be implemented in electronic or other forms.

The foregoing descriptions are merely implementations of this application, but are not intended to limit the protection scope of this application. Any variation or replacement readily figured out by one of ordinary skilled in the art within the technical scope disclosed in this application shall fall within the protection scope of this application. Therefore, the protection scope of this application shall be subject to the protection scope of the claims.

1. An electronic device, comprising:
a conductive frame having a first position and a second position, wherein a frame between the first position and the second position is a first frame; and
an antenna comprising the first frame, wherein the antenna is configured to generate a first resonance and a second resonance, wherein
a ratio of a frequency of the first resonance to a frequency of the second resonance is greater than 1 and less than or equal to 1.5;
an operating frequency band of the antenna comprises a first frequency band, and a frequency in the first frequency band is between the frequency of the first resonance and the frequency of the second resonance; and
an axial ratio of circular polarization of the antenna in the first frequency band is less than or equal to 10 dB.

2. The electronic device according to claim 1, wherein a polarization manner for the first resonance is orthogonal to a polarization manner for the second resonance.

3. The electronic device according to claim 1, wherein in the first frequency band, a difference between a first gain generated by the antenna and a second gain generated by the antenna is less than 10 dB, wherein the first gain is a gain of a pattern generated by the antenna in a first polarization direction, the second gain is a gain of a pattern generated by the antenna in a second polarization direction, and the first polarization direction is orthogonal to the second polarization direction.

4. The electronic device according to claim 1, wherein in the first frequency band, a difference between a first phase generated by the antenna and a second phase generated by the antenna is greater than 25° and less than 155°, wherein the first phase is a phase of the antenna in a first polarization direction, the second phase is a phase of the antenna in a second polarization direction, and the first polarization direction is orthogonal to the second polarization direction.

5. The electronic device according to claim 1, wherein the ratio of the frequency of the first resonance to the frequency of the second resonance is greater than or equal to 1.2 and less than or equal to 1.35.

6. The electronic device according to claim 1, wherein the antenna further comprises a ground plate;
the first frame comprises a ground point; and
the first frame is grounded at the ground point through the ground plate.

7. The electronic device according to claim 6, wherein in the first frequency band, a current on the first frame is symmetrically distributed along the ground point at a first moment, and the current on the first frame is asymmetrically distributed along the ground point at a second moment.

8. The electronic device according to claim 6, wherein the ground point is disposed in a central region of the first frame.

9. The electronic device according to claim 6, wherein the first frame is divided into a first radiator part and a second radiator part by the ground point, and an electrical length of the first radiator part is different from an electrical length of the second radiator part.

10. The electronic device according to claim 6, further comprising a capacitor, wherein one end of the capacitor is electrically connected to the first frame at a ground point, and the other end of the capacitor is grounded.

11. The electronic device according to claim 1, wherein the antenna further comprises a ground plate;
the first frame is grounded at the first position and the second position through the ground plate; and
the first frame has a slot.

12. The electronic device according to claim 11, wherein in a third frequency band, an electric field between the first frame and the ground plate is symmetrically distributed along a virtual axis of the first frame at a first moment, and the electric field between the first frame and the ground plate is asymmetrically distributed along the virtual axis at a second moment.

13. The electronic device according to claim 11, wherein the slot is disposed in a central region of the first frame.

14. The electronic device according to claim 11, wherein the first frame is divided into a first radiator part and a second radiator part by the slot, and an electrical length of the first radiator part is different from an electrical length of the second radiator part.

15. The electronic device according to claim 11, further comprising an inductor, wherein two ends of the inductor are electrically connected to the first frame on two sides of the slot separately.

16. The electronic device according to claim 1, further comprising a resonant stub, wherein the frame comprises a first edge and a second edge that intersect at an angle;
at least a part of the first frame is located on the first edge;
the resonant stub is disposed between the second edge and a ground plate, and one end of the resonant stub is electrically connected to the ground plate; and
a distance between the resonant stub and the first frame is less than half of a length of the second edge.

17. The electronic device according to claim 1, wherein
the frame comprises a first edge and a second edge that intersect at an angle;
at least a part of the first frame is located on the first edge;
a slot is disposed on a ground plate corresponding to the second edge; and
a distance between the slot and the first frame is less than half of a length of the second edge.

18. The electronic device according to claim 6, wherein
the first frame further comprises a first feed point, and the first feed point is disposed between the ground point or a slot and the first position; and
no feed point is comprised between the ground point or the slot and the second position.

19. The electronic device according to claim 6, further comprising a switch and a feed unit, wherein
the first frame further comprises a first feed point and a second feed point, the first feed point is disposed between a ground point or a slot and the first position, and the second feed point is disposed between the ground point or the slot and the second position;
the switch comprises a common port, a first port, and a second port, and the switch is configured to switch a status of electrical connection between the common port and the first port or the second port; and
the common port is electrically connected to the feed unit, the first port is electrically connected to the first frame at the first feed point, and the second port is electrically connected to the first frame at the second feed point.

20. The electronic device according to claim 6, wherein
the first frame comprises a first feed point and a second feed point, the first feed point is disposed between the ground point or a slot and the first position, and the second feed point is disposed between the ground point or the slot and the second position; and
a difference between a phase of an electrical signal fed at the first feed point and a phase of an electrical signal fed at the second feed point is 90°+25°.
